(19) United States
(12) Patent Application Publication
(10) Pub. No.: US 2021/0129697 A1
(43) Pub. Date: May 6, 2021

(54) SYSTEM, APPARATUS AND METHOD FOR PROVIDING MOBILE CHARGING SERVICE

(71) Applicant: LG Electronics Inc., Seoul (KR)

(72) Inventor: Chang Woo CHO, Gyeonggi-do (KR)

(21) Appl. No.: 16/752,106

(22) Filed: Jan. 24, 2020

(30) Foreign Application Priority Data
Oct. 30, 2019 (KR) 10-2019-0136786

(51) Int. Cl. B60L 53/38; H04W 4/029; H04W 76/10; H02J 7/02; H02J 50/12; B60L 53/12; B64C 39/02; B60L 53/14; B60L 53/66

(52) U.S. Cl. CPC B60L 53/38; H04W 4/029; H04W 76/10; H02J 7/02; B60K 6/28; B60L 53/12; B64C 39/024; B60L 53/14; B60L 53/66; H02J 50/12

(57) ABSTRACT

Disclosed is a mobile charging service provision method in which a system and apparatus providing the mobile charging service are operated by executing artificial intelligence (AI) algorithms and/or machine learning algorithms in a 5G environment connected for Internet-of-Things. The mobile charging service provision method according to one embodiment of the present disclosure includes transmitting driving information for platooning to a charge request vehicle, establishing, based on a selected charging mode, a connection with the charge request vehicle for wireless power supply or wired power supply, and based on the connection, performing charging of the charge request vehicle.

### CROSS-REFERENCE TO RELATED APPLICATION

This application claims the benefit of priority to Korean Patent Application No. 10-2019-0136786, filed on Oct. 30, 2019, the entire disclosure of which is incorporated herein by reference.

### BACKGROUND

### 1. Technical Field

The present disclosure relates to a mobile charging service provision system, apparatus, and method capable of simultaneously charging multiple electric vehicles during driving.

### 2. Description of Related Art

Generally, electric vehicles are vehicles powered by electricity, and may include hybrid electric vehicles, plug-in hybrid electric vehicles, hydrogen fuel cell electric vehicles, and the like. In such electric vehicles, the most important feature is the batteries, and in particular, the weight reduction and miniaturization of batteries, and the reduction of charging time may be extremely important for an electric vehicle. Therefore, in order to promote the distribution of electric vehicles and commercialize autonomous vehicles, it will become increasingly important to increase the convenience of charging through establishing charging infrastructure.

In this regard, existing technology has enabled the battery pack of an electric vehicle of which the battery is completely discharged to be rapidly and conveniently charged using unmanned aerial drones deployed at drone charging stations located nearby. However, it may be difficult for unmanned aerial drones to carry large-capacity batteries, and furthermore, charging for an extended period of time or charging more than one vehicle simultaneously may be difficult.

The background art described above is technical information retained by the present inventors in order to derive the present disclosure, or acquired by the present inventors in the process of deriving the present disclosure, and thus is not necessarily known art disclosed to the general public before the filing of the present application.

### SUMMARY OF THE INVENTION

An aspect of the present disclosure is to enable simultaneous charging of multiple electric vehicles during driving.

Another aspect of the present disclosure is to enable wired charging or wireless charging of a vehicle needing to be charged, by using a mobile charging vehicle capable of performing wireless charging and wired charging while driving in a platoon.

Another aspect of the present disclosure is to enable a connection for charging by using an unmanned aerial vehicle provided with a robot hand.

Another aspect of the present disclosure is to enable continuous charging by using a mobile charging vehicle mounted with large-capacity batteries.

Another aspect of the present disclosure is to enable optimal charging by sharing charging information on the basis of a resource-sharing network.

The present disclosure is not limited to what has been described above, and other aspects not mentioned herein will be apparent from the following description to one of ordinary skill in the art to which the present disclosure pertains. Furthermore, it will be understood that aspects and advantages of the present disclosure may be achieved by the means set forth in claims and combinations thereof.

According to one embodiment of the present disclosure, a mobile charging service provision method may include allowing a plurality of electric vehicles to be charged simultaneously during driving.

More specifically, the mobile charging service provision method according to this embodiment of the present disclosure may include receiving a charge request from one or more vehicles, and providing location information of a charge-available area on the basis of the location of a charge request vehicle that has requested to be charged.

In addition, the mobile charging service provision method may include collecting vehicle information of the charge request vehicle upon entry of the charge request vehicle into the charge-available area and selecting a charging mode, and transmitting driving information for platooning to the charge request vehicle.

In addition, the mobile charging service provision method may include establishing a connection for wireless power supply or wired power supply with the charge request vehicle based on the selected charging mode, and performing charging of the charge request vehicle based on the connection.

Through the mobile charging service provision method according to this embodiment of the present disclosure, a mobile charging vehicle capable of performing wireless charging and wired charging may be used to perform wireless charging or wired charging while driving in a platoon with vehicles needing to be charged, thereby allowing a plurality of electric vehicles to be charged simultaneously and enabling efficient charging based on charging modes.

In addition, in order to implement the present disclosure, there may be further provided other methods, other systems, and a computer-readable recording medium having a computer program stored thereon to execute the methods.

Aspects, features, and advantages of the present disclosure other than the ones mentioned previously will become more apparent with reference to the accompanying drawings, the appended claims, and the detailed description of the present disclosure.

According to embodiments of the present disclosure, by using a mobile charging vehicle capable of wireless charging and wired charging and having the mobile charging vehicle perform wireless charging or wired charging while driving in a platoon with the vehicles needing to be charged, a plurality of electric vehicles can be charged simultaneously, thus increasing product satisfaction and reliability.

In addition, by installing a large-capacity battery, it is possible to enable high-efficiency fast charging during wired charging and increase efficiency during wireless charging, thus increasing the utility of a mobile charging service provision apparatus.

In addition, by monitoring in real time the locations of the mobile charging vehicle and the charge request vehicle, a charging state, and nearby road conditions, it is possible to prevent unexpected events from occurring.

In addition, by training a deep neural network on the basis of data obtained from monitoring in real time the locations of the mobile charging vehicle and the charge request vehicle, a charging state, and nearby road conditions, it is possible to enable optimal charging.

In addition, by providing the mobile charging service through 5G network-based communications, and thereby enabling fast data processing, it is possible to further improve the performance of the mobile charging service provision system.

In addition, although the mobile charging service provision apparatus is a mass-produced uniform product, since the user perceives it as a personalized device, the effects of being a user-customized product may be produced.

Advantages of the present disclosure are not limited to the foregoing features, and any other advantages not mentioned will become more apparent from the following detailed description to those skilled in the art to which the present disclosure pertains.

### BRIEF DESCRIPTION OF DRAWINGS

The above and other aspects, features, and advantages of the present disclosure will become apparent from the detailed description of the following aspects in conjunction with the accompanying drawings, in which:

FIG. 1 is a diagram of an example of an environment providing an artificial intelligence (AI) system-based mobile charging service, including a cloud network;

FIG. 2 is a schematic diagram illustrating a communication environment of the mobile charging service provision system according to one embodiment of the present disclosure;

FIG. 3 is a schematic block diagram of a mobile charging service provision system according to one embodiment of the present disclosure;

FIG. 4 is a diagram showing an example of the basic operation of an autonomous vehicle and a 5G network in a 5G communication system;

FIG. 5 is a diagram showing an example of an application operation of an autonomous vehicle and a 5G network in a 5G communication system;

FIGS. 6 to 9 are diagrams showing examples of the operation of an autonomous vehicle using a 5G communication;

FIG. 10 is a diagram showing a charging assistance module according to one embodiment of the present disclosure;

FIG. 11 is a diagram showing a wireless charging module according to one embodiment of the present disclosure;

FIG. 12 is a diagram showing a wired charging module according to one embodiment of the present disclosure;

FIG. 13 is a block diagram showing a processor according to one embodiment of the present disclosure;

FIG. 14 is a diagram illustrating a top wireless charging method according to one embodiment of the present disclosure;

FIG. 15 is a diagram illustrating a bottom wireless charging method according to one embodiment of the present disclosure;

FIG. 16 is a diagram illustrating a wired charging method according to one embodiment of the present disclosure;

FIG. 17 is a schematic diagram illustrating a connection with a charge request vehicle according to one embodiment of the present disclosure;

FIG. 18 is a diagram illustrating an inter-vehicle connection method according to one embodiment of the present disclosure; and

FIG. 19 is a flowchart illustrating a mobile charging service provision method according to one embodiment of the present disclosure.

### DETAILED DESCRIPTION

Advantages and features of the present disclosure and methods of achieving the advantages and features will be more apparent with reference to the following detailed description of embodiments in connection with the accompanying drawings. However, the description of particular embodiments is not intended to limit the present disclosure to the particular embodiments disclosed herein, but on the contrary, it should be understood that the present disclosure is to cover all modifications, equivalents and alternatives falling within the spirit and scope of the present disclosure. The embodiments disclosed below are provided so that the present disclosure will be thorough and complete, and also to provide a more complete understanding of the scope of the present disclosure to those of ordinary skill in the art. In the interest of clarity, not all details of the relevant art are described in detail in the present specification if so deemed that such details are not necessary to obtain a complete understanding of the present disclosure.

The terminology used herein is used for the purpose of describing particular embodiments and is not intended to limit the scope of the present disclosure. The singular forms include the plural references unless the context clearly dictates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The terms such as “first,” “second,” and other numerical terms may be used herein only to describe various elements, but these elements should not be limited by these terms. These terms such as “first,” “second,” and other numerical terms, are used only to distinguish one element from another element.

A vehicle described in the present specification may refer to an automobile and a motorcycle. Hereinafter, the vehicle will be exemplified as an automobile.

The vehicle described in the present disclosure may include, but is not limited to, a vehicle having an internal combustion engine as a power source, a hybrid vehicle having an engine and an electric motor as a power source, and an electric vehicle having an electric motor as a power source.

The vehicles described in the present application may be autonomous vehicles, and also vehicles specially manufactured to efficiently charge a moving vehicle, but are not limited thereto.

Hereinafter, embodiments of the present disclosure will be described in detail with reference to the accompanying drawings. Like reference numerals designate like elements throughout the specification, and overlapping descriptions of the elements will not be provided.

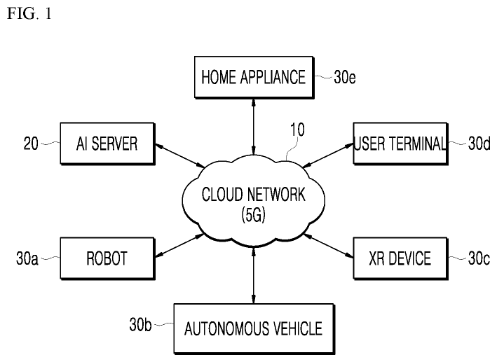

FIG. 1 is a diagram of an example of an environment providing an artificial intelligence (AI) system-based mobile charging service, including a cloud network.

Referring to FIG. 1, a mobile charging service provision environment may include an AI server 20, a robot 30a, an autonomous vehicle 30b, an extended reality (XR) device 30c, a user terminal 30d or a home appliance 30e, and a cloud network 10. Here, in the mobile charging service provision environment, at least one of the AI server 20, the robot 30a, the autonomous vehicle 30b, the XR device 30c, or the user terminal 30d or the home appliance 30e may be connected to the cloud network 10. Here, the robot 30a, the autonomous vehicle 30b, the XR device 30c, and the user terminal 30d or the home appliance 30e, to which AI technology is applied, may be referred to as AI devices 30a to 30e.

The robot 30a may refer to a machine which automatically handles a given task by its own ability, or which operates autonomously. In particular, a robot having a function of recognizing an environment and performing an operation according to its own determination may be referred to as an intelligent robot. Robots 30a may be classified into industrial, medical, household, and military robots, according to the purpose or field of use.

The autonomous vehicle 30b refers to a vehicle which travels without manipulation of a user or with minimal manipulation of the user, and may also be referred to as an autonomous-driving vehicle. For example, autonomous driving may include a technology in which a driving lane is maintained, a technology such as adaptive cruise control in which a speed is automatically adjusted, a technology in which a vehicle automatically drives along a defined route, and a technology in which a route is automatically set when a destination is set. In this case, an autonomous vehicle may be considered as a robot with an autonomous driving function.

The XR device 30c refers to a device using extended reality (XR), which collectively refers to virtual reality (VR), augmented reality (AR), and mixed reality (MR). VR technology provides objects or backgrounds of the real world only in the form of CG images, AR technology provides virtual CG images overlaid on physical object images, and MR technology employs computer graphics technology to mix and merge virtual objects with the real world. XR technology may be applied to a head-mounted display (HMD), a head-up display (HUD), a mobile phone, a tablet PC, a laptop computer, a desktop computer, a TV, digital signage, and the like. A device employing XR technology may be referred to as an XR device.

The user terminal 30d may be provided with a service for operating or controlling the mobile charging service provision system through an authentication process after accessing a mobile charging service provision system application or a mobile charging service provision system website. In the present embodiment, the user terminal 30d that has completed the authentication process may operate a mobile charging service provision system 1 and control a mobile charging service provision apparatus 100. In the present embodiment, the user terminal 30d may be a desktop computer, a smartphone, a notebook, a tablet PC, a smart TV, a cell phone, a personal digital assistant (PDA), a laptop, a media player, a micro server, a global positioning system (GPS) device, an electronic book terminal, a digital broadcast terminal, a navigation device, a kiosk, an MP3 player, a digital camera, a home appliance, and other mobile or immobile computing devices operated by the user, but is not limited thereto. In addition, the user terminal 30d may be a wearable terminal having a communication function and a data processing function, such as a watch, glasses, a hair band, and a ring. The user terminal 30d is not limited thereto. Any terminal that is capable of performing web browsing may be used without limitation.

The home appliance 30e may include any one among electronic devices provided in a home. In particular, the home appliance 30e may include a terminal capable of implementing speech recognition, artificial intelligence, and the like, and a terminal for outputting at least one of an audio signal or a video signal. In addition, the home appliance 30e may include various home appliances (for example, a washing machine, a drying machine, a clothes processing apparatus, an air conditioner, a kimchi refrigerator, or the like), without being limited to specific electronic devices.

The cloud network 10 may include part of the cloud computing infrastructure or refer to a network existing in the cloud computing infrastructure. Here, the cloud network 10 may be constructed by using a 3G network, a 4G or Long Term Evolution (LTE) network, or a 5G network. That is, the devices 30a to 30e and 20 constituting the mobile charging service provision environment may be connected to one another through the cloud network 10. In particular, the individual devices (30a to 30e, 20) may communicate with each other through a base station, but may also communicate directly with each other without relying on the base station.

The cloud network 10 may include, for example, wired networks such as local area networks (LANs), wide area networks (WANs), metropolitan area networks (MANs), and integrated service digital networks (ISDNs), or wireless networks such as wireless LANs, code division multiple access (CDMA), Bluetooth, and satellite communication, but the scope of the present disclosure is not limited thereto. Furthermore, the cloud network 10 may transmit and receive information using short-range communications or long-distance communications. The short-range communication may include Bluetooth®, radio frequency identification (RFID), infrared data association (IrDA), ultra-wideband (UWB), ZigBee, and Wi-Fi (wireless fidelity) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA).

The cloud network 10 may include connection of network elements such as hubs, bridges, routers, switches, and gateways. The cloud network 10 may include one or more connected networks, including a public network such as the Internet and a private network such as a secure corporate private network. For example, the network may include a multi-network environment. The access to the cloud network 10 can be provided via one or more wired or wireless access networks. Furthermore, the cloud network 10 may support 5G communication and/or an Internet of things (IoT) network for exchanging and processing information between distributed components such as objects.

The AI server 20 may include a server performing AI processing and a server performing computations on big data. In addition, the AI server 20 may be a database server that provides big data necessary for applying various artificial intelligence algorithms and data for operating the mobile charging service provision system 1. In addition, the AI server 20 may include a web server or an application server that enables remote control of the operation of the mobile charging service provision apparatus 100 by using a mobile charging service provision system application or a mobile charging service provision system web-browser installed on the user terminal 30d.

In addition, the AI server 20 may be connected, through the cloud network 10, to at least one of the robot 30a, the autonomous vehicle 30b, the XR device 30c, the user terminals 30d, or the home appliance 30e, which are AI devices constituting the mobile charging service provision environment, and may assist at least in part with the AI processing of the connected AI devices 30a to 30e. Here, the AI server 20 may train the AI network according to a machine learning algorithm instead of the AI devices 30a to 30e, and may directly store a learning model or transmit the learning model to the AI devices 30a to 30e. Here, the AI server 20 may receive input data from the AI devices 30a to 30e, infer a result value from the received input data by using the learning model, generate a response or control command based on the inferred result value, and transmit the generated response or control command to the AI devices 30a to 30e. Similarly, the AI devices 30a to 30e may infer a result value from the input data by employing the learning model directly and generate a response or control command based on the inferred result value.

Artificial intelligence (AI) is an area of computer engineering and information technology that studies how to make computers perform things humans are capable of doing with human intelligence, such as reasoning, learning, self-improving, and the like, or how to make computers mimic such intelligent human behaviors.

In addition, artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed. More specifically, machine learning is a technology that studies and builds systems capable of learning, making predictions, and enhancing its own performance on the basis of experiential data, and algorithms for such systems. Machine learning algorithms, rather than executing rigidly-set static program commands, may take an approach that builds models for deriving predictions and decisions from inputted data.

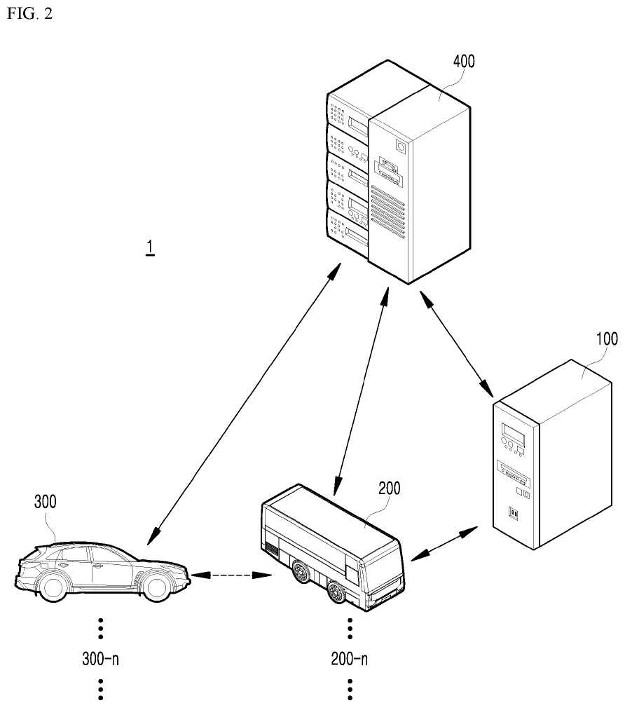

The present embodiment particularly relates to the autonomous vehicle 30b. Thus, among the above-mentioned AI devices to which the technology is applied, the autonomous vehicle 30b will be described in the embodiments below. However, in the present embodiment, a mobile charging vehicle (200 of FIG. 2) and the charge request vehicle (300 of FIG. 2) are not limited to the autonomous vehicle 30b, and may refer to any vehicles, including the autonomous vehicle 30b and regular vehicles. In the present embodiment, a vehicle provided with the service provision system 1 may be used as an example.

FIG. 2 is a schematic diagram illustrating a communication environment of the mobile charging service provision system according to one embodiment of the present disclosure. Hereinbelow, common parts previously described with reference to FIG. 1 will not be described, so as to avoid repeated description.

Referring to FIG. 2, the mobile charging service provision system 1 may essentially include the mobile charging service provision apparatus 100, a mobile charging vehicle 200, and a server 400, and may perform charging in response to a charge request from a charge request vehicle 300. In addition, the mobile charging service provision system 1 may further comprise other components, such as a user terminal, a network, an n-th mobile charging vehicle 200-n, and an n-th charge request vehicle 300-n. Here, the mobile charging service provision apparatus 100 may be provided in each of at least one mobile charging vehicle 200, but is not limited thereto.

In this embodiment, the server 400 may include, for example, an AI server 20, a mobile edge computing (MEC) server, and a control server for the process of the mobile charging service provision apparatus 100, as shown in FIG. 1, or the server 400 may refer to a combination of the aforementioned components. When the server 400 is another server that is not specified in the present embodiment, the connection relationship illustrated in FIG. 2 may be changed.

By receiving data collected from the mobile charging vehicle 200, the AI server may learn to select a charging mode, connect a power supply line based on the location of the charge request vehicle 300, and predict and handle unexpected events that may occur during charging.

The MEC server may act as a general server, and may be connected to a base station (BS) next to a road in a radio access network (RAN) to provide flexible vehicle-related services and efficiently operate the network. In particular, network-slicing and traffic scheduling policies supported by the MEC server can assist the optimization of the network. The MEC server is integrated inside the RAN, and may be located in an S1-user plane interface (for example, between the core network and the base station) in a 3GPP system. The MEC server may be regarded as an independent network element, and does not affect the connection of the existing wireless networks. The independent MEC servers may be connected to the base station via the dedicated communication network and may provide specific services to various end-users located in the cell. These MEC servers and the cloud servers may be connected to each other through an Internet-backbone, and share information with each other. In addition, the MEC servers may operate independently and control a plurality of base stations. Services for autonomous vehicles, application operations such as virtual machines (VMs), and operations at the edge side of mobile networks based on a virtualization platform may be performed. The base station (BS) may be connected to both the MEC servers and the core network to enable flexible user traffic scheduling required for performing the provided services. When a large amount of user traffic occurs in a specific cell, the MEC server may perform task offloading and collaborative processing based on the interface between neighboring base stations. That is, since the MEC server has an open operating environment based on software, new services of an application provider may be easily provided. Since the MEC server performs the service at a location near the end-user, the data round-trip time is shortened and the service providing speed is high, thereby reducing the service waiting time. MEC applications and virtual network functions (VNFs) may provide flexibility and geographic distribution in service environments. When using this virtualization technology, various applications and network functions can be programmed, and only specific user groups may be selected or compiled for them. Therefore, the provided services may be applied more closely to user requirements. In addition to centralized control ability, the MEC server may minimize interaction between base stations. This may simplify the process for performing basic functions of the network, such as handover between cells. This function may be particularly useful in autonomous driving systems used by a large number of users. In the autonomous driving system, the terminals of the road may periodically generate a large amount of small packets. In the RAN, the MEC server may reduce the amount of traffic that must be delivered to the core network by performing certain services. This may reduce the processing burden of the cloud in a centralized cloud system, and may minimize network congestion. The MEC server may integrate network control functions and individual services, which can increase the profitability of Mobile Network Operators (MNOs). Installation density adjustment may enable fast and efficient maintenance and upgrades.

However, as an example, the mobile charging vehicle 200 and the charge request vehicle 300 in the present embodiment may be autonomous vehicles. In addition, the charge request vehicle 300 may be implemented as an electric vehicle, and here, the electric vehicle may refer to a wide range of electric vehicles that are provided with electric batteries and can be charged. That is, the mobile charging vehicle 200 may refer to a vehicle manufactured in order to charge the battery of the charge request vehicle 300.

Meanwhile, in the present embodiment, the charge request vehicle 300 may include, for example, a vehicle communication module, a vehicle control module, a vehicle user interface module, a driving operation module, a vehicle driving module, a driving module, a navigation module, a sensing module. The charge request vehicle 300 may include components other than the components described, or may not include some of the components described, depending on the embodiment.

Here, the charge request vehicle 300 may be an autonomous driving vehicle, and may be switched from an autonomous driving mode to a manual mode, or switched from the manual mode to the autonomous driving mode according to a user input received through the vehicle user interface module. In addition, the charge request vehicle 300 may be switched from an autonomous mode to a manual mode, or switched from the manual mode to the autonomous mode depending on the driving situation. Here, the driving situation may be judged by at least one of information received by the vehicle communication module, external object information detected by the sensing module, or navigation information acquired by the navigation module.

When the charge request vehicle 300 is operated in the autonomous mode, the charge request vehicle 300 may be operated under the control of the operation module that controls driving, unparking, and parking operations. Alternatively, when the charge request vehicle 300 is operated in the manual mode, the charge request vehicle 300 may be operated by an input inputted by the driver through the driving operation module. The charge request vehicle 300 may be connected to an external server over a communication network, and may be capable of moving along a predetermined route without the driver's interventions by using autonomous driving technology.

The vehicle user interface module is for communication between the charge request vehicle 300 and a vehicle user, and may receive an input signal from the user, transmit the received input signal to the vehicle control module, and provide information held by the charge request vehicle 300 to the user under the control of the vehicle control module. In the present embodiment, through the vehicle user interface module, the charging service provision service may be requested, or the charging service information may be received.

The operation module may control a variety of operations of the vehicle 300 and in particular, in the autonomous driving mode, may control a variety of operations of the charge request vehicle 300. The operation module may include a driving module, an unparking module, and a parking module, but is not limited thereto. In addition, the operation module may include a processor under the control of the vehicle control module. Each module of the operation module may include a processor individually. When the operation module is implemented in software, it may be a sub-concept of the vehicle control module, depending on the embodiment.

The driving module, the unparking module, and the parking module can perform driving, unparking, and parking of the vehicle 300, respectively. In addition, the driving module, the unparking module, and the parking module may each receive object information from the sensing module, and provide a control signal to the vehicle driving module, to thereby perform driving, unparking, and parking of the charge request vehicle 300, respectively. In addition, the driving module, the unparking module, and the parking module may each receive a signal from an external device through the vehicle communication module, and provide a control signal to the vehicle driving module, to thereby perform driving, unparking, and parking of the charge request vehicle 300, respectively. In addition, the driving module, the unparking module, and the parking module may each receive navigation information from the navigation module and provide a control signal to the vehicle driving module, to thereby perform driving, unparking, and parking of the charge request vehicle 300, respectively. The navigation module may provide the navigation information to the vehicle control module. The navigation information may include at least one of map information, set destination information, route information according to destination setting, information about various objects on the route, lane information, or current location information of the vehicle.

The sensing module can sense the state of the charge request vehicle 300, that is, detect a signal about the state of the charge request vehicle 300 by using a sensor mounted on the charge request vehicle 300, and can acquire travel route information of the charge request vehicle 300 according to the sensed signal. In addition, the sensing module may provide acquired movement path information to the vehicle control module. In addition, the sensing module may sense objects in the proximity of the charge request vehicle 300 by using a sensor mounted in the charge request vehicle 300.

Meanwhile, although the aforementioned components and descriptions of the aforementioned components were provided with regard to the charge request vehicle 300, the same components and descriptions may be applied to the movable charging vehicle 200.

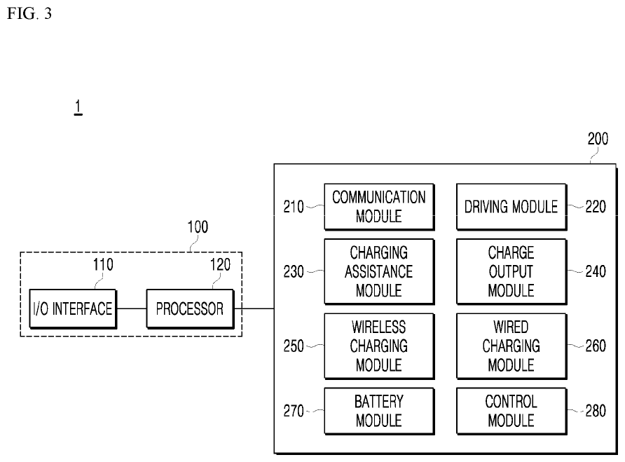

FIG. 3 is a schematic block diagram of a mobile charging service provision system according to one embodiment of the present disclosure. Hereinbelow, parts previously described with reference to FIG. 1 and FIG. 2 will not be described to avoid repeated description.

Referring to FIG. 3, the mobile charging service provision system 1 may include the mobile charging service provision apparatus 100 and the mobile charging vehicle 200. Although the mobile charging service provision apparatus 100 and the mobile charging vehicle 200 are separately illustrated in FIG. 3, in the present embodiment, the mobile charging service provision apparatus 100 may be mounted in the mobile charging vehicle 200. Alternatively, the mobile charging service provision apparatus 100 may be provided outside the mobile charging vehicle 200, but is not limited thereto. However, in the present embodiment, a communication module 210, a driving module 220, a charging assistance module 230, a charge output module 240, a wireless charging module 250, a wired charging module 260, a battery module 270, and a control module 280 may be provided in the mobile charging vehicle 200, and operated by control signals of a processor 120.

That is, upon receipt of a charge request from a random vehicle, the mobile charging service provision system 1 may perform charging of the random vehicle that has sent the charge request, by operating, through an I/O interface 110, one or more of the communication module 210, the driving module 220, the charging assistance module 230, the charge output module 240, the wireless charging module 250, the wired charging module 260, the battery module 270, or the control module 280 of the mobile charging vehicle 200.

Here, the I/O interface 110 is for communication between the mobile charging vehicle 200 and the charge request vehicle 300, and may receive an input signal from the charge request vehicle 300 and transmit the received input signal to the processor 120, and the charging service can be provided by the mobile charging vehicle 200 under the control of the processor 120. Furthermore, the I/O interface 110 may be for communication between a user and the mobile charging vehicle 200. That is, the I/O interface 110 may receive a user's input signal and transmit the received input signal to the processor 120.

In the present embodiment, the system 1 may select a charging mode of the charge request vehicle 300 that has requested to be charged, and according to the charging mode, may have the wireless charging module 250 or the wired charging module 260 move to the charge request vehicle 300 by using the charging assistance module 230, to perform the charging.

Describing the mobile charging vehicle 200 in greater detail, the communication module 210 may be a vehicle communication module for performing communication between the mobile charging vehicle 200 and the charge request vehicle 300, and with an external device. The communication module 210 may support communication in a plurality of communication modes, may receive a server signal from a server, and may transmit a signal to the server. In addition, the communication module 210 may receive a signal from one or more charge request vehicles 300 and transmit a signal to the charge request vehicle 300, and may receive a signal from the user terminal and transmit a signal to the user terminal. That is, the external device may include other vehicles including the charge request vehicle 300, the user terminal, a server system, and the like.

In addition, in the present embodiment, the communication module 210 enables communication with the charging assistance module 230, the wireless charging module 250, and the wired charging module 260. Here, the communication module 210 may transmit a signal to at least one of the charging assistance module 230, the wireless charging module 250, or the wired charging module 260, so as to allow at least one of the charging assistance module 230, the wireless charging module 250, or the wired charging module 260 to move to the charge request vehicle 300 to perform charging, and may receive a signal from at least one of the charging assistance module 230, the wireless charging module 250, or the wired charging module 260.

In addition, the communication module 210 may include a communication module for in-vehicle communications. Herein, the plurality of communication modes may include an inter-vehicle communication mode for communicating with another vehicle including the charge request vehicle 300, a server communication mode for communicating with an external server, a short-range communication mode for communicating with a user terminal such as an in-vehicle user terminal, and an in-vehicle communication mode for communicating with in-vehicle units. That is, the communication module 210 may include modules such as a wireless communication module, a vehicle to everything (V2X) communication module, and a short-range communication module.

The wireless communication module may transmit and receive signals to and from a user terminal or a server through a mobile communication network. Here, the mobile communication network is a multiple access system capable of supporting communication with multiple users by sharing used system resources (bandwidth, transmission power, or the like). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi-carrier frequency division multiple access (MC-FDMA) system.

The V2X communication module may transmit and receive signals with an RSU through a vehicle to infrastructure (V2I) communication protocol in a wireless manner, may transmit and receive signals with another vehicle through a vehicle to vehicle (V2V) communication protocol, and may transmit and receive signals with a user terminal, that is, a pedestrian or a user, through a vehicle to pedestrian (V2P) communication protocol. That is, the V2X communication module may include an RF circuit capable of implementing protocols of communication with infrastructure (V2I), inter-vehicle communication (V2V), and communication with a user terminal (V2P). That is, the communication module 210 may include at least one of a transmission antenna, a reception antenna, a radio frequency (RF) circuit capable of implementing various communication protocols, and an RF element in order to perform communication.

The short range communication module may be connected to the user terminal of the driver through a short range wireless communication module. In this case, the short-range communication module may be connected to the user terminal through wired communication as well as wireless communication. For example, if the user terminal of the driver is registered in advance, the short-range communication module may allow the user terminal to automatically connect to the charge request vehicle 200 when the registered user terminal is recognized within a predetermined distance from the vehicle 200 (for example, when inside the vehicle). That is, the communication module 210 can perform short-range communication, GPS signal reception, V2X communication, optical communication, broadcast transmission/reception, and intelligent transport system (ITS) communication functions. The communication module 210 may support short-range communication by using at least one among Bluetooth™, radio frequency identification (RFID), Infrared Data Association (IrDA), Ultra Wideband (UWB), ZigBee, near field communication (NFC), Wi-Fi, Wi-Fi Direct, and Wireless Universal Serial Bus (USB) technologies. The communication module 210 may further support other functions than the functions described, or may not support some of the functions described, depending on the embodiment.

Depending on the embodiment, the overall operation of each module of the communication module 210 may be controlled by a separate processor provided in the communication module 210. The communication module 210 may include a plurality of processors, or may not include a processor. When the communication module 210 does not include a processor, the communication module 210 may be operated under control of either a processor of another device in the mobile charging vehicle 200 or the vehicle control module.

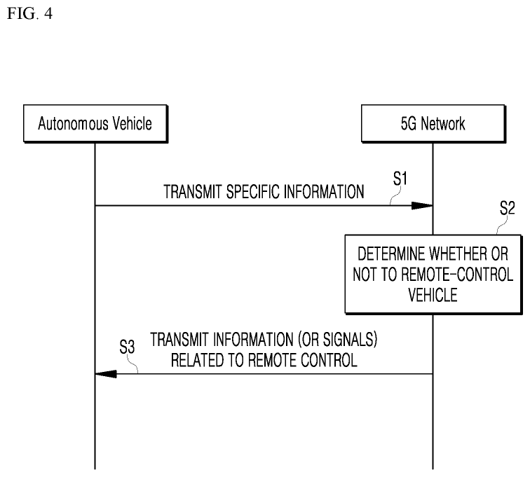

FIG. 4 is a diagram illustrating an example of the basic operation of an autonomous vehicle and a 5G network in a 5G communication system.

The communication module 210 may transmit specific information over a 5G network when the mobile charging vehicle 200 is operated in the autonomous driving mode (S1).

The specific information may include autonomous driving related information.

The autonomous driving related information may be information directly related to the driving control of the vehicle. For example, the autonomous driving related information may include at least one of object data indicating an object near the vehicle, map data, vehicle status data, vehicle location data, or driving plan data.

The autonomous driving related information may further include service information necessary for autonomous driving. For example, the specific information may include information about the destination inputted through the user interface and the safety rating of the vehicle.

In addition, the 5G network can determine whether or not the vehicle is to be remotely controlled (S2).

The 5G network may include a server or a module for performing remote control related to autonomous driving.

The 5G network may transmit information (or signals) related to the remote control to an autonomous vehicle (S3).

As described above, information related to the remote control may be a signal directly applied to the autonomous vehicle and may further include service information necessary for autonomous driving. The autonomous vehicle according to one embodiment of the present disclosure may receive service information, such as insurance for each road segment selected on a travel route and dangerous road segment information, through a server connected to the 5G network, to provide services relevant to autonomous driving.

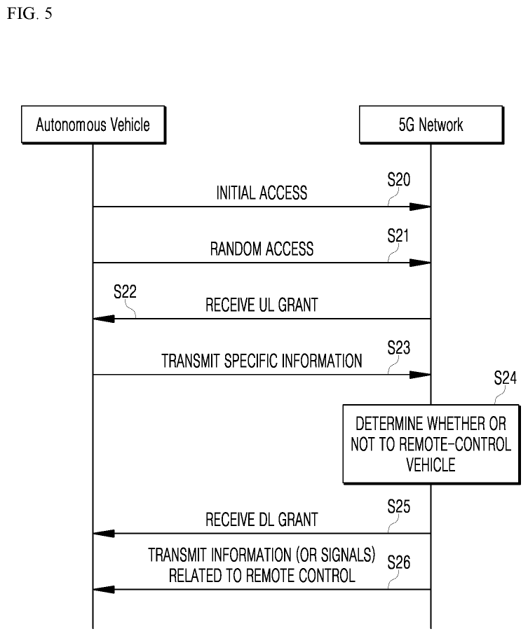

Hereinbelow, essential processes for the 5G communication between the autonomous mobile charging vehicle 200 and the 5G network (for example, an initial access process between the vehicle and the 5G network) will be briefly described with reference to FIG. 5 to FIG. 9 below.

First, one example of application operations performed through the autonomous mobile charging vehicle 200 and the 5G network in the 5G communication system is as follows.

The mobile charging vehicle 200 executes an initial access procedure with the 5G network (initial access step, S20). Here, the initial access procedure includes a cell search process for downlink (DL) synchronization acquisition and a process for system information acquisition.

Also, the mobile charging vehicle 200 executes a random access procedure with the 5G network (random access step, S21). Here, the random access procedure includes an uplink (UL) synchronization acquisition process or a preamble transmission process for UL data transmission, a random access response reception process, and the like.

The 5G network may transmit an uplink (UL) grant for scheduling transmission of specific information to the autonomous mobile charging vehicle 200 (UL grant reception step, S22).

The procedure by which the mobile charging vehicle 200 receives the UL grant includes a scheduling process in which time/frequency resources are allocated for transmission of UL data to the 5G network.

Also, the autonomous mobile charging vehicle 200 may transmit specific information over the 5G network based on the UL grant (specific information transmission step, S23).

Meanwhile, the 5G network may determine whether the mobile charging vehicle 200 is to be remotely controlled, based on the specific information transmitted from the mobile charging vehicle 200 (vehicle remote control determining step, S24).

The autonomous mobile charging vehicle 200 may receive a DL grant through a physical DL control channel in order to receive a response on pre-transmitted specific information from the 5G network (DL grant reception step, S25).

Subsequently, the 5G network may transmit information (or signals) related to the remote control to the autonomous mobile charging vehicle 200, based on the DL grant (remote control-related information transmission step, S26).

Although the procedure in which the initial access process and/or the random access process between the 5G network and the autonomous mobile charging vehicle 200, and the DL grant reception process are combined has been described as an example, the present disclosure is not limited thereto.

For example, an initial access procedure and/or a random access procedure may be performed through an initial access step, a UL grant reception step, a specific information transmission step, a remote control decision step of the vehicle, and an information transmission step associated with remote control. Further, for example, the initial access procedure and/or the random access procedure may be executed through a random access step, a UL grant reception step, a specific information transmission step, a vehicle remote control determination step, and a remote control-related information transmission step. The control of the autonomous mobile charging vehicle 200 may be achieved by a process that combines an AI operation and the DL grant reception process, through the specific information transmission step, the vehicle remote control determination step, the DL grant reception step, and the remote control-related information transmission step.

The operation of the autonomous mobile charging vehicle 200 described above is merely an example, and the present disclosure is not limited thereto.

For example, the operation of the autonomous mobile charging vehicle 200 may be performed by selectively combining the initial access step, the random access step, the UL grant reception step, or the DL grant reception step with the specific information transmission step, or the remote control-related information transmission step. The operation of the autonomous mobile charging vehicle 200 may include the random access step, the UL grant reception step, the specific information transmission step, and the remote control-related information transmission step. The operation of the autonomous mobile charging vehicle 200 may include the initial access step, the random access step, the specific information transmission step, and the remote control-related information transmission step. The operation of the autonomous mobile charging vehicle 200 may include the UL grant reception step, the specific information transmission step, the DL grant reception step, and the remote control-related information transmission step.

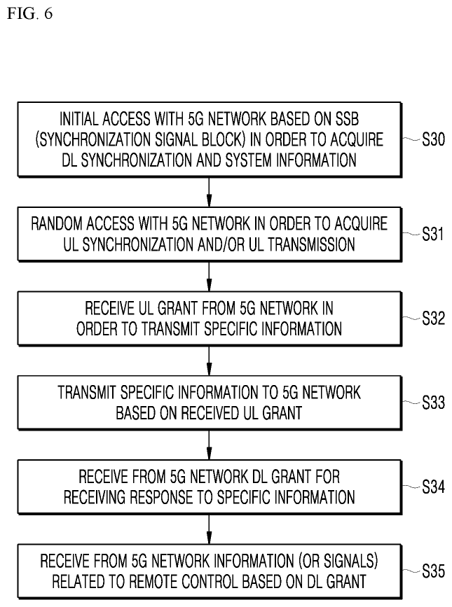

As illustrated in FIG. 6, the mobile charging vehicle 200 including an autonomous driving module may execute an initial access procedure with the 5G network based on Synchronization Signal Block (SSB) for acquiring DL synchronization and system information (initial access step, S30).

In addition, the autonomous mobile charging vehicle 200 may execute a random access procedure with the 5G network for UL synchronization acquisition and/or UL transmission (random access step, S31).

Meanwhile, the autonomous mobile charging vehicle 200 may receive the UL grant from the 5G network for transmitting specific information (UL grant receiving step, S32).

The autonomous mobile charging vehicle 200 may transmit the specific information to the 5G network based on the UL grant (specific information transmission step, S33).

The autonomous mobile charging vehicle 200 may receive the DL grant from the 5G network for receiving a response to the specific information (DL grant receiving step, S34).

The autonomous mobile charging vehicle 200 may receive remote control-related information (or signals) from the 5G network based on the DL grant (remote control-related information reception step, S35).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. Further, a QCL relationship may be added to the DL grant reception step with respect to the beam receiving direction of the PDCCH including the DL grant.

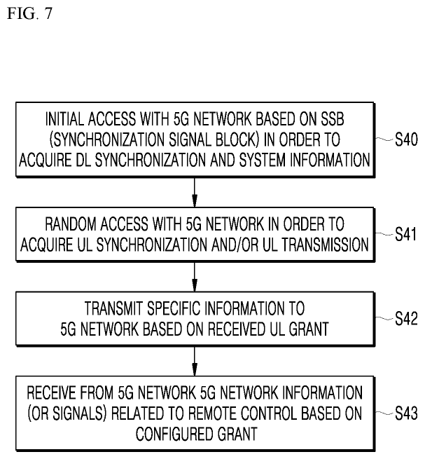

As illustrated in FIG. 7, the autonomous mobile charging vehicle 200 may execute an initial access procedure with the 5G network based on SSB for acquiring DL synchronization and system information (initial access step, S40).

In addition, the autonomous mobile charging vehicle 200 may execute a random access procedure with the 5G network for UL synchronization acquisition and/or UL transmission (random access step, S41).

In addition, the autonomous vehicle 200 may transmit specific information based on a configured grant to the 5G network (UL grant reception step, S42). In other words, instead of receiving the UL grant from the 5G network, the configured grant may be received.

The autonomous mobile charging vehicle 200 may receive remote control-related information (or signals) from the 5G network based on the configured grant (remote control-related information reception step, S43).

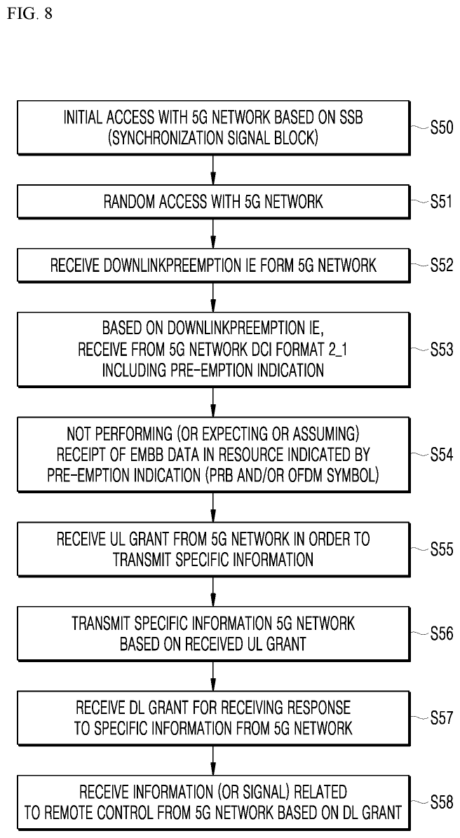

As illustrated in FIG. 8, the autonomous mobile charging vehicle 200 may execute an initial access procedure with the 5G network based on SSB for acquiring DL synchronization and system information (initial access step, S50).

In addition, the autonomous mobile charging vehicle 200 may execute a random access procedure with the 5G network for UL synchronization acquisition and/or UL transmission (random access step, S51).

In addition, the autonomous mobile charging vehicle 200 may receive Downlink Preemption (DL) and Information Element (IE) from the 5G network (DL Preemption IE reception step, S52).

The autonomous mobile charging vehicle 200 may receive DCI (Downlink Control Information) format 2_1 including preemption indication based on the DL preemption IE from the 5G network (DCI format 2_1 reception step, S53).

The autonomous mobile charging vehicle 200 may not perform (or expect or assume) the reception of eMBB data in the resource (PRB and/or OFDM symbol) indicated by pre-emption indication (eMBB data reception omission step, S54).

Meanwhile, the autonomous mobile charging vehicle 200 may receive the UL grant from the 5G network for transmitting specific information (UL grant reception step, S55).

The autonomous mobile charging vehicle 200 may transmit the specific information to the 5G network based on the UL grant (specific information transmission step, S56).

The autonomous mobile charging vehicle 200 may receive the DL grant from the 5G network for receiving a response to the specific information (DL grant reception step, S57).

The autonomous mobile charging vehicle 200 may receive remote control-related information (or signals) from the 5G network based on the DL grant (remote control-related information reception step, S58).

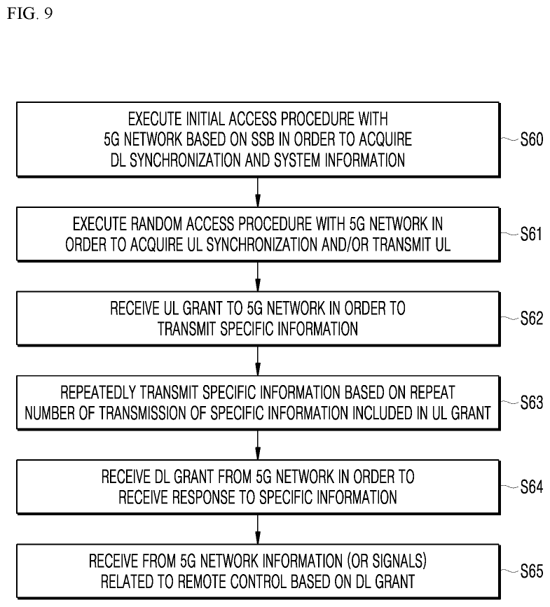

As illustrated in FIG. 9, the autonomous mobile charging vehicle 200 may execute an initial access procedure with the 5G network based on SSB for acquiring DL synchronization and system information (initial access step, S60).

In addition, the autonomous mobile charging vehicle 200 may execute a random access procedure with the 5G network for UL synchronization acquisition and/or UL transmission (random access step, S61).

Meanwhile, the autonomous mobile charging vehicle 200 may receive the UL grant from the 5G network for transmitting specific information (UL grant reception step, S62).

When specific information is transmitted repeatedly, the UL grant may include information on the number of repetitions, and the specific information may be repeatedly transmitted based on information on the number of repetitions (specific information repeated transmission step, S63).

The autonomous mobile charging vehicle 200 may transmit the specific information to the 5G network based on the UL grant.

Also, the repeated transmission of specific information may be performed through frequency hopping, the first specific information may be transmitted in the first frequency resource, and the second specific information may be transmitted in the second frequency resource.

The specific information may be transmitted through Narrowband of 6 Resource Block (6RB) and 1 Resource Block (1RB).

The autonomous mobile charging vehicle 200 may receive the DL grant from the 5G network for receiving a response to the specific information (DL grant reception step, S64).

The autonomous mobile charging vehicle 200 may receive remote control-related information (or signals) from the 5G network based on the DL grant (remote control-related information reception step, S65).

The above-described 5G communication technique can be applied in combination with the embodiments proposed in this specification described with reference to FIG. 1 to FIG. 19, or supplemented to specify or clarify the technical feature of the embodiments proposed in this specification.

The operation module may control a variety of operations of the mobile charging vehicle 200, and in particular, in the autonomous driving mode, may control a variety of operations of the charge request vehicle 200. Particularly, in the present embodiment, the mobile charging vehicle 200 may perform platooning with a plurality of vehicles through the driving module 220. As the plurality of vehicles platoon, the vehicles may form a network, and can be driven while keeping a uniform distance between the vehicles. The platooning vehicles may receive information on surroundings through vehicle to everything (V2X) communication, and use the received information to ensure safety of the driving. In the present embodiment, the mobile charging vehicle 200 may be referred to as a leading vehicle (LV) in the platoon, and charge request vehicles 300 to 300-n following the mobile charging vehicle 200 may be referred to as slave vehicles (SVs) or as following vehicles (FVs).

In addition, the mobile charging vehicle 200 in an autonomous driving system may perform platooning by controlling the driving module 220 through a transmitter and a receiver for communication with the server, and the processor 120 functionally connected with the transmitter and the receiver. Here, the transmitter and the receiver may be included in the I/O interface 110 or the communication module 210.

Here, the driving module 220 may acquire driving information from each of a plurality of platooning vehicles. The driving information may include first distance information relating to the distance of lateral slippage of each of the plurality of vehicles with respect to the driving direction on the road and second distance information relating to the distance of longitudinal slippage of each of the plurality of vehicles with respect to the driving direction on the road, and control information for controlling the speed and position of each of the plurality of vehicles in the platoon based on the first distance information and the second distance information may be transmitted to each of the plurality of vehicles. In addition, the driving information may further include weight information showing the weight of each of the plurality of vehicles.

In addition, the driving module 220 may, based on the driving information, calculate the position of each of the vehicles in the platoon, the distance between each of the vehicles, and the speed of each of the vehicles. Here, the control information may include at least one of position information relating to the calculated position, inter-vehicle distance information relating to the distance between the vehicles, or speed information relating to the speed. Furthermore, the driving module 220 may transmit to the server a request message requesting road information relating to road characteristics on a travel route, and may receive a response message containing the road information from the server. The road information may include icy road information showing whether or not icy roads exist on the travel route, and road state information showing the state of the roads. That is, in the present embodiment, the platooning vehicles may receive the information on surroundings through V2X communications to synchronize braking and acceleration between the vehicles.

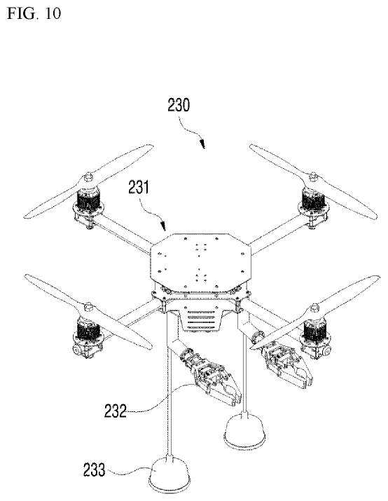

FIG. 10 is a diagram showing a charging assistance module according to one embodiment of the present disclosure. Hereinafter, the charging assistance module 230 will be described in greater detail with reference to FIG. 10.

The charging assistance module 230 may be configured to include a main body 231, an operating module 232, and a fix/release module 233. In the present embodiment, the charging assistance module 230 is implemented as an unmanned aerial vehicle as an example, and the following description will be provided accordingly. However, the charging assistance module 230 is not limited to an unmanned aerial vehicle.

The charging assistance module 230 may be configured such that the charging assistance module 230 can move to a set position, move an object to the set position and attach/detach the object to a vehicle, or connect and disconnect a power supply line. In other words, the charging assistance module 230 may be an unmanned aerial vehicle which can be provided in the mobile charging vehicle 200 and move the wireless charging module 250 and the wired charging module 260 to different positions. More than one charging assistance module 230 may be provided in the mobile charging vehicle 200, and each charging assistance module 230 may be provided in the mobile charging vehicle 200 to which it is registered, and after moving, may return to the corresponding mobile charging vehicle 200. In addition, the charging assistance module 230 may be manually operated by a manager who has boarded the mobile charging vehicle 200, or may be manually operated by a manager on the ground. In addition, the charging assistance module 230 may be automatically controlled by a set flight program.

The main body 231 is a body portion in which the operating module 232, the fix/release module 233, and the like are mounted. In addition, one or more propellers may be vertically installed in the main body 231 to enable horizontal and vertical movement of the charging assistance module 230. In addition, one or more propellers may be spaced apart from each other in the main body 231, and a motor for driving the propellers may also be disposed. A plurality of propeller support members may be provided radially from the main body 231. Each of the propeller support members may be provided with a motor, and each motor may be provided with the propellers. A plurality of propellers may be disposed symmetrically about the center of the main body 231. In addition, the rotation direction of the motor may be determined such that clockwise directions and counterclockwise directions are combined in the rotation directions of the plurality of propellers. The rotation directions for one pair of the propellers disposed symmetrically with respect to the center of the main body 231 may be configured to be identical (for example, a clockwise direction). Meanwhile, another pair of propellers may have a rotation direction opposite to that of the one pair of the propellers (for example, a counterclockwise direction).

The operating module 232 may be implemented in a shape similar to a human hand, and can execute the functions of picking up and putting down an object. As such, the operating module 232 may have rotation modules installed in fingers so as to enable holding of an object, and may include a variety of sensors attached to each fingertip and joint to enable smooth operation. As such, the operating module 232 can be implemented to be flexible in their movement and resistant to damage by external forces. Accordingly, in the present embodiment, by using the operating module 232, the power supply lines can be connected, disconnected, or moved, and the wireless charging module 250 and the wired charging module 260 can be moved to a desired position.

The fix/release module 233 may be disposed on the bottom surface of the main body 231 while being spaced apart from each other. In addition, the fix/release module 233 may be attached to the top of the mobile charging vehicle 200 or charge request vehicle 300 so as to allow the charging assistance module 230 to land on and attach to the top of the mobile charging vehicle 200 or charge request vehicle 300 without scratching the vehicle. Here, the fix/release module 233 may be made of an adherent material that enables instantaneous adhering upon landing, or may be configured to be capable of being connected and disconnected by a control signal of the processor 120. In addition, the fix/release module 233 may include cushioning support members that minimize the impact due to collisions when the charging assistance module 230 lands on top of the mobile charging vehicle 200 or charge request vehicle 300. That is, in the present embodiment, by using the fix/release module 233, the charging assistance module 230 can be fixed to the mobile charging vehicle 200 or charge request vehicle 300, and perform operations such as connecting or disconnecting power supply lines. Alternatively, the charging assistance module 230 may be implemented in a different aerial vehicle with a variety of structures other than the one described above.

Meanwhile, although not illustrated in FIG. 3, a sensor unit including an external communication module, a memory, and various sensors may be provided inside the main body 231.

The external communication module may receive input of or receive information from the processor 120, and may output or transmit information. In addition, the external communication module may transmit and receive information with external devices. The external communication module may receive a variety of instruction signals from the processor 120. That is, the external communication module may receive, from the processor 120, area information for driving, a driving route, driving instructions, and operation instructions for connecting power supply lines, for example. Here, the area information may include no-fly region information and approach-restricted distance information. In addition, the external communication module may receive various instruction signals, not only from the processor 120 but also from an external server, a terminal, or the like. In the present embodiment, the external communication module may receive information on which of the wireless charging module 250 or the wired charging module 260 is to be moved, and receive information on a connection method for connecting the mobile charging vehicle 200 and the charge request vehicle 300 for charging.

That is, in the present embodiment, the charging assistance module 230 and the mobile charging vehicle 200, or the server or terminal, may be connected to one another by a wireless communication method. The wireless communication method may use, for example, Global System for Mobile communication (GSM), code division multiple access (CDMA), code division multiple access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A).

In addition, the wireless communication method may use wireless internet technology. The wireless internet technology may include, for example, Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A), and 5G. In particular, a 5G communication network may be used to transmit and receive data and enable faster responses.

The memory stores various information required for controlling the charging assistance module 230, and may include a volatile or non-volatile recording medium. In addition, a map of a driving route may be stored in the memory. The map may be one inputted by the processor, or may be one that the charging assistance module 230 has autonomously learned and generated.

The sensor unit may include 3-axis gyroscopes, 3-axis accelerometers, and 3-axis magnetometers for measuring rotational motion, and a GPS sensor and a barometric pressure sensor for measuring translational motion.

In addition, the sensor unit may include a camera sensor. The camera sensor may include an image sensor (for example, a CMOS image sensor) configured to include at least one optical lens and a plurality of photodiodes (for example, pixels) forming an image using the light passing through the optical lens, and may include a digital signal processor (DSP) for forming an image based on signals outputted from the photodiodes. The digital signal processor may generate a static image, and may also be capable of generating a video made of frames of static images. That is, in the present embodiment, by using the camera sensor, external events that occur during charging may be monitored.

The charge output module 240 may refer to an output port capable of connecting a power supply line (for example, a charging line) of the mobile charging vehicle 200. The charge output module 240 may include a plurality of charging output modules 240, and is not limited in terms of installation location.

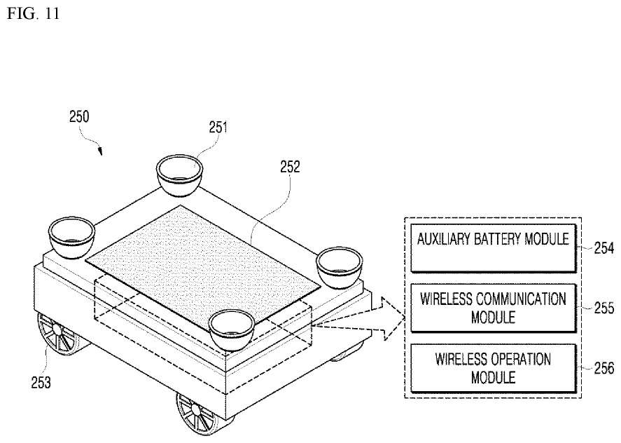

FIG. 11 is a diagram showing a wireless charging module according to one embodiment of the present disclosure. Hereinafter, the wireless charging module 250 will be described in greater detail with reference to FIG. 11.

The wireless charging module 250 may include a wireless charging fix/release module 251, a wireless charging pad 252, a wireless charging mobile module 253, an auxiliary battery module 254, a wireless communication module 255, and a wireless operation module 256.

A plurality of wireless charging modules 250 may be provided in the mobile charging vehicle 200 and can be moved to the charge request vehicle 300 by the charging assistance module 230. The wireless charging module 250 may include the wireless charging fix/release module 251 so that the wireless charging module 250 can be moved to the charge request vehicle 300 and attached to the charge request vehicle 300 for charging.

The wireless charging fix/release module 251 may be made of a material capable of adhering to the top or the underside of the charge request vehicle 300, to be able to be adhered and fixed to the vehicle. Alternatively, the wireless charging fix/release module 251 can be implemented such that the wireless charging fix/release module 251 can attach or detach by a control signal of the processor 120. That is, the wireless charging fix/release module 251 may be configured such that in response to receipt of a charge execution signal from the processor 120, the wireless charging fix/release module 251 attaches (fixes) to the top or underside of the vehicle and executes charging, and once a charge completion signal is inputted, the wireless charging fix/release module 251 detaches from the top or underside of the vehicle and returns to the mobile charging vehicle 200.

The wireless charging pad 252 is a wireless power transmission pad that includes a magnetic induction coil and executes charging by inductive charging. A magnetic induction method is a short-distance charging technology. A strong magnetic force can be generated by winding a current around a coil in a manner similar to a magnetic resonance technique. Here, a magnetic force is induced when coils made with the same frequency overlap. The magnetic induction technique generates electricity therefrom. However, the charging mode of the wireless charging pad 252 is not limited thereto, and can be implemented to enable charging by magnetic resonance.

The wireless charging mobile module 253 enables the wireless charging module 250 to travel to a set location according to a control signal of the processor 120, and can be implemented in the form of wheels.

The auxiliary battery module 254 may include a battery for wireless charging. The auxiliary battery module 254, when the battery is drained, can be charged through the battery module 270 of the mobile charging vehicle 200 when positioned in the mobile charging vehicle 200.

The wireless communication module 255 may receive input of or receive information from the processor 120, and may output or transmit information. In addition, the wireless communication module 255 may transmit and receive information with external devices. The wireless communication module 255 may receive a variety of instruction signals from the processor 120. That is, the wireless communication module 255 may receive instructions such as a driving route, driving instructions, charging instructions, and the like, from the processor 120. In addition, the wireless communication module 255 may receive a variety of instruction signals, not only from the processor 120 but also from an external server, a terminal, the charging assistance module 230, and the like. Also, in the present embodiment, the wireless communication module 255 may receive location information of the charge request vehicle 300, and may cause the wireless charging module 250 to drive autonomously to the charge request vehicle 300. The wireless connection method for the wireless communication module 255 with the processor 120, an external server, a terminal, the charging assistance module 230, and the like may be the same as a wireless connection method for the charging assistance module 230.

The wireless operation module 256 may cause the wireless charging module 250 to drive autonomously according to control instructions from the processor 120. Also, the wireless operation module 256 may control the fixing or releasing of the wireless charging fix/release module 251. That is, the wireless operation module 256 is for overall control over the wireless charging module 250, and may control the wireless operation module 256 according to control instructions from the processor 120, but also may operate by self-learning.

Meanwhile, although not illustrated in the drawings, the wireless charging module 250 may further include, for example, a camera sensor, various detection sensors (crash sensor, location sensor, etc.), and a memory.

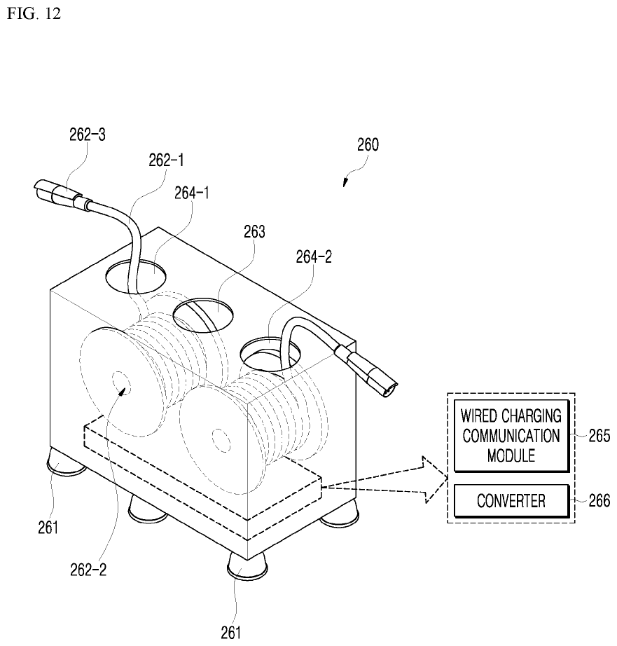

FIG. 12 is a diagram showing a wired charging module according to one embodiment of the present disclosure. Hereinafter, the wired charging module 260 will be described in greater detail with reference to FIG. 12.

The wired charging module 260 may include wired charging fix/release modules 261, a power supply line 262-1, a motor 262-2, a charging handle 262-3, an input terminal 263, a first output terminal 264-1, a second output terminal 264-2, a wired charging communication module 265, and a converter 266.

A plurality of wired charging modules 260 may be provided in the mobile charging vehicle 200 and can be moved to the charge request vehicle 300 by the charging assistance module 230. Here, the wired charging module 260 may serve as a bridge for the power supply lines, and serve to prevent interference of the power supply lines (for example, stretching/twisting). The wired charging module 260 may include the wired charging fix/release modules 261 capable of moving to the charge request vehicle 300 and attaching to the charge request vehicle 300 for charging. However, the wired charging module 260 may be formed to be capable of rotating in order to prevent stretching or twisting of the power supply lines.

The wired charging fix/release modules 261 may be made of a material capable of adhering to the top or the underside of the charge request vehicle 300, to be able to be adhered and fixed to the vehicle. However, the wired charging fix/release modules 261 can be implemented such that the wired charging fix/release modules 261 can be activated (fixed) or deactivated (released) by a control signal of the processor 120, and when rotating, only the wired charging fix/release module 261 positioned in a central axis becomes activated and rotates.

In the wired charging module 260, a power supply line 262-1, a motor 262-2, and a charging handle 262-3 may be provided, and the power supply line 262-1 may be automatically wound or unwound by the motor 262-2. The power supply line 262-1 may include a power supply line corresponding to a first output terminal 264-1 and a power supply line corresponding to a second output terminal 264-2. The charging handle 262-3 is configured to be inserted into a charging port of the charge request vehicle 300, and may include a cushioning member for preventing collisions upon release.

The input terminal 263 is a terminal to which a power supply line from the charge output module 240 of the mobile charging vehicle 200 is connected, and which receives power. In addition, in the present embodiment, the input terminal 263 may be connected with the power supply line from the output terminal of another charge request vehicle 300-1 connected to the mobile charging vehicle 200, and receive power from the other charge request vehicle 300-1. The power supply lines of the first output terminal 264-1 and the second output terminal 264-2 may be connected to the charging port of the charge request vehicle 300 and output power. In addition, the power supply lines of the first output terminal 264-1 and the second output terminal 264-2 may be connected to the other charge request vehicle 300-1 and output power. Meanwhile, in the present embodiment, a configuration such that it is possible to cut electricity between the input terminal 263 and the first output terminal 264-1 and second output terminal 264-2 in case of a particular event may be provided.

The wired charging communication module 265 may receive input of or receive information from the processor 120, and may output or transmit information. In addition, the wired charging communication module 265 may transmit and receive information with external devices. The wired charging communication module 265 may receive a variety of instruction signals from the processor 120. That is, the wired charging communication module 265 may receive instructions such as charge execution, charge completion, and the like, from the processor 120. In addition, the wired charging communication module 265 may receive various instruction signals, not only from the processor 120 but also from an external server, a terminal, the charging assistance module 230, and the like. In addition, in the present embodiment, the wired charging communication module 265 may receive operation instruction signals, such as disconnection of a power supply line, rotation of the wired charging module 260, or the like, in the event of unexpected events such as tangling of the power supply line, collision, and the like. The wireless connection method for the wired charging communication module 265 with the processor 120, an external server, a terminal, the charging assistance module 230, and the like, may be the same as a wireless connection method for the charging assistance module 230.

A converter 266 is for regulating voltage/current depending on the battery type. That is, by rectifying a voltage through the converter 266, the voltage supplied to the mobile charging vehicle 200 can be made compatible with the battery of the charge request vehicle 300. Accordingly, the mobile charging service provision system 1 of the present embodiment can support a variety of battery types.

A battery module 270 may be an energy storage device consisting of a plurality of battery packs. The plurality of battery packs may be chargeable battery packs. The battery packs may consist of a plurality of battery cells, which may be large-capacity batteries. In addition, the battery module 270 may include a holding means capable of holding the plurality of battery packs in an arranged state. The battery module 270 preferably includes secondary batteries capable of charging and discharging, but is not limited thereto.

In response to receipt of a charge request from more than one vehicle through the communication module 210, the control module 280 may provide, to the charge request vehicle 300, location information of a charging-available region based on the location of the charge request vehicle 300 that has requested to be charged. In addition, when the charge request vehicle 300 enters the charging-available area, the control module 280 may collect the vehicle information of the charge request vehicle 300 for charging, and select a charging mode.

In addition, the control module 280 may transmit driving information for platooning to the charge request vehicle 300 through the communication module 210, and perform synchronization. In addition, when the wireless charging mode is selected, the control module 280 may transport the wireless charging module 250 to the charge request vehicle 300 by using the charging assistance module 230, and wirelessly connect the wireless charging module 250 to the charge request vehicle 300. In addition, when the wired charging mode is selected, the control module 280 may transport the wired charging module 260 to the charge request vehicle 300 by using the charging assistance module 230 and connect the wired charging module 260 to the charge request vehicle 300 by wire. In addition, after confirming that the connection with the charge request vehicle 300 is complete, the control module 280 may execute charging of the charge request vehicle 300 while platooning, through the driving module 220.

The control module 280 can control, as a kind of central processor, the entire operation of the mobile charging service provision system 1 by driving control software installed in the memory (not illustrated). The control module 280 may include devices of all kinds capable of processing data, such as a processor. Here, the term “processor” may refer to a data processing device built in hardware, which includes physically structured circuits in order to perform functions represented as a code or command present in a program. Examples of the data processing device built in hardware may include microprocessors, central processors (CPUs), processor cores, multiprocessors, application-specific integrated circuits (ASICs), digital signal processors (DSPs), digital signal processing devices (DSPDs), programmable logic devices (PLDs), processors, controllers, micro-controllers, and field programmable gate array (FPGA), but the present disclosure is not limited thereto.

In the present embodiment, in order for the mobile charging service provision system 1 to perform optimal charging, the control module 280 may perform machine learning, such as deep learning, and the memory may store therein data used for the machine learning, result data, and the like.

Deep learning, which is a subfield of machine learning, enables data-based learning through multiple layers. Deep learning may represent a set of machine learning algorithms that extract core data from a plurality of data sets as the number of layers increases.

Deep learning structures may include an artificial neural network (ANN), and may include a convolutional neural network (CNN), a recurrent neural network (RNN), a deep belief network (DBN), and the like. The deep learning structure according to the present embodiment may use various structures well known in the art. For example, the deep learning structure according to the present disclosure may include a CNN, an RNN, a DBN, and the like. An RNN is widely used in natural language processing and may configure an artificial neural network structure by building up layers at each instant in a structure that is effective for processing time-series data which vary with time. A DBN may include a deep learning structure formed by stacking up multiple layers of restricted Boltzmann machines (RBM), which is a deep learning scheme. When a predetermined number of layers are constructed by repetition of RBM learning, the DBN having the predetermined number of layers may be constructed. A CNN includes a model mimicking a human brain function, built on the assumption that when a person recognizes an object, the brain extracts basic features of the object and recognizes the object based on the results of complex processing in the brain.

Further, the artificial neural network may be trained by adjusting weights of connections between nodes (if necessary, adjusting bias values as well) so as to produce a desired output from a given input. Also, the ANN may continuously update the weight values through learning. Furthermore, methods such as back propagation may be used in training the ANN.

That is, an artificial neural network may be installed in the mobile charging service provision system 1, and the control module 280 may include an artificial neural network, for example, a deep neural network (DNN) such as a CNN, an RNN, and a DBN. Accordingly, the control module 280 may train the deep neural network to provide an optimal charging service. As a machine learning method for such an artificial neural network, both unsupervised learning and supervised learning may be used. The control module 280 may perform control such that an artificial neural network structure is updated after training according to settings.

In this embodiment, parameters for pre-trained deep neural network learning may be collected. Here, data used by an actual user may be collected in order to refine the learning model. In case of having user data inputted from the user, in the present embodiment, the inputted data may be stored on the server and/or the memory regardless of the result of the trained model. That is, in the present embodiment, the mobile charging service provision system 1 may generate big data by storing data for providing an optimal charging service on the server, and may update the mobile charging service provision system 1 with relevant parameters by executing deep learning at the server edge so that the parameters become more and more elaborate. However, in the present embodiment, the update may be performed by executing deep learning independently at the mobile charging service provision system 1 edge or the mobile charging vehicle 200 edge. That is, in the present embodiment, the initial configuration of the mobile charging service provision system 1 or the mobile charging vehicle 200 upon initial launch may be provided with laboratory condition deep learning parameters, and updating may be performed through data that accumulates along with charging services provided and performed by the mobile charging vehicle 200. Therefore, in the present embodiment, the collected data may be labeled so that a result can be obtained through supervised learning, and the data may be stored in the memory in the mobile charging service provision system to complete an evolving algorithm. That is, the mobile charging service provision system 1 may collect data for providing a charging service and thus generate a training data set, and may train a model using the training data set through a machine learning algorithm to thereby determine a trained model. In addition, the mobile charging service provision system 1. may collect data used by an actual user, and perform re-training in the server to thereby generate a re-trained model. Therefore, in the present embodiment, even after being determined as a trained model, data may be continuously collected, and the model may be re-trained by applying a machine learning model, to thereby improve the performance as a re-trained model.

The memory (not illustrated) may store various kinds of information necessary for the mobile charging service provision system 1, and may include a volatile or nonvolatile recording medium. Here, the memory may include magnetic storage media or flash storage media, but the scope of the present disclosure is not limited thereto. The memory as described above may include an internal memory and/or an external memory, and may further include volatile memory such as DRAM, SRAM, or SDRAM; non-volatile memory such as one time programmable ROM (OTPROM), PROM, EPROM, EEPROM, mask ROM, flash ROM, NAND flash memory, and NOR flash memory; a flash drive such as SSD, a compact flash (CF) card, a SD card, a micro-SD card, a mini-SD card, an Xd card, or a memory stick, or a storage device such as HDD.

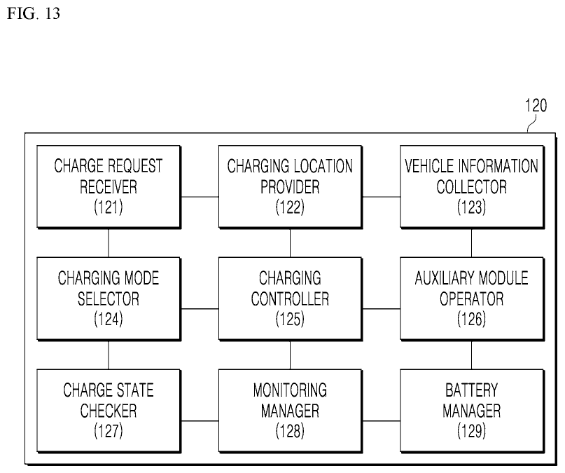

The processor 120 may perform training in connection with the control module 280, or may receive a training result from the control module 280. In the present embodiment, the processor 120 may be provided separately from the control module 280, as illustrated in FIG. 3, or may be integrated with the control module 280 to perform the same operation. Also, the processor 120 may be provided within the server 400 shown in FIG. 2. Hereinafter, the details of the processor 120 will be described with reference to FIG. 13.

FIG. 13 is a block diagram showing a processor according to one embodiment of the present disclosure. In the following description, repeated description of common parts previously described with reference to FIG. 1 through FIG. 12 will be omitted.

Referring to FIG. 13, the processor 120 may include a charge request receiver 121, a charging location provider 122, a vehicle information collector 123, a charging mode selector 124, a charging controller 125, an auxiliary module operator 126, a charge state checker 127, a monitoring manager 128, and a battery manager 129.

The mobile charging service provision system 121 may receive a charge request from one or more vehicles. That is, when a vehicle that needs to be charged sends a charge request to the mobile charging service provision system 1, the mobile charging service provision system 121 can recognize the charge request vehicle 300 that has requested to be charged. Here, the charge request of the charge request vehicle 300 may be received by a control server, which then transmits information on the charge request vehicle 300 to the closest mobile charging vehicle 200. In addition, the mobile charging service provision system 121 may receive a charge request from a vehicle located within a set area.

The charging location provider 122 may provide the charge request vehicle 300 with location information on a charging-available area, based on the location of the charge request vehicle 300 that has sent the charge request. A charging-available area may refer to an area within a set area relative to the mobile charging vehicle 200. In addition, the set area may be set by factors such as the distance the wireless charging module 250 is capable of traveling, the distance within which wired connection using the wired charging module 260 is possible, and the area capable of accommodating platooning.

The vehicle information collector 123 may collect the vehicle information of the charge request vehicle 300 for charging upon entry of the charge request vehicle 300 into the charging-accessible area. Here, the vehicle information of the charge request vehicle 300 may include the charging state, the charging type, and the location of the charge request vehicle 300. In addition, the vehicle information collector 123 may send a request for billing information of the charge request vehicle 300 in order to charge for the charging, and receive the request.

The charging mode selector 124 may select the charging mode based on the vehicle information of the charge request vehicle 300. That is, based on at least one of a charge state of the charge request vehicle 300, the charging type of the charge request vehicle 300, and the location of the charge request vehicle 300, the charging mode selector 124 may select one of a top wireless charging mode, a bottom wireless charging mode, and a wired charging mode as the charging mode.

For example, the charging mode selector 124 may check the charge state of the charge request vehicle 300, and if the charge level is below a reference level, may select the wired charging mode and enable high-efficiency fast charging. In addition, if wired charging is the only charging mode available according to the charging type of the charge request vehicle 300, the charging mode selector 124 may select the wired charging mode. In addition, the charging mode selector 124 may select an optimal charging mode based on the location and charge state of the vehicles being currently being charged and the location of the charge request vehicle 300. Here, the optimal charging mode may be selected according to a pre-set priority order based on the location and the charge state of the charge request vehicle 300. In the present embodiment, the priority order may be set through training a deep neural network.

However, in the present embodiment, the charging mode selector 124 may select the charging mode based on a charging mode selected from the charge request vehicle 300. That is, when the charge request vehicle 300 has selected the charging mode as one of the top wireless charging mode, the bottom wireless charging mode, or the wired charging mode, the charging controller 125 may execute charging in the selected charging mode.

In addition, the charging controller 125 may transmit driving information for platooning to the charge request vehicle 300, and execute synchronization. In addition, the charging controller 125 may establish a wireless or wired connection with the charge request vehicle 300 according to the charging mode selected by the charging mode selector 124, and may check whether the connection is completed. In addition, the charging controller 125 may execute charging of the charge request vehicle 300 while platooning with the charge request vehicle 300.

Here, the charging controller 125 may establish a wireless or wired connection with the charge request vehicle 300 by controlling the charging assistance module 230 through the auxiliary module operator 126.

That is, the auxiliary module operator 126 may cause the charging assistance module 230 to move to a set location according to a control command of the charging controller 125, and may cause an object to be transported (the wireless charge module or the wired charge module) to be attached and fixed to the charge request vehicle 300. In addition, the auxiliary module operator 126 may cause the wired charging module 260 to connect to or release from the charge request vehicle 300 by manipulating the power supply line of the wired charging module 260 through the charging assistance module 230.

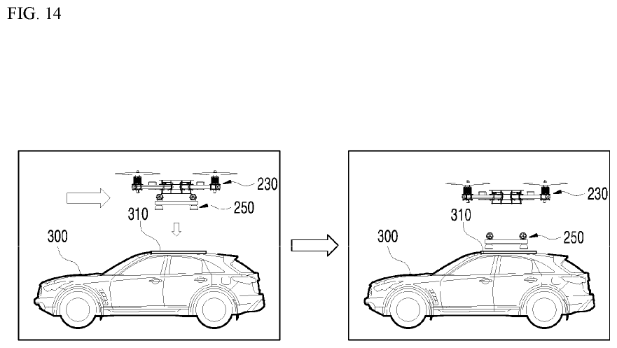

FIG. 14 is a diagram illustrating a top wireless charging method according to one embodiment of the present disclosure. Referring to FIG. 14, in the case in which the top wireless charging mode is selected as the charging mode of the charge request vehicle 300, the charging controller 125 may move the wireless charging module 250 to the top of the charge request vehicle 300 by controlling the charging assistance module 230 through the auxiliary module operator 126. Here, the charging controller 125 may move the charging assistance module 230 to a position where a wireless power receiving pad 310 is located on top of the charge request vehicle 300. Thereafter, the charging assistance module 230 may return to the mobile charging vehicle 200.

Subsequently, the charging controller 125 may cause the wireless charging module 250 to attach to the top of the charge request vehicle 300 so as to allow the wireless charge pad (252 in FIG. 11) of the wireless charging module 250 to be near to or in contact with the wireless power receiving pad 310 of the charge request vehicle 300. Thereafter, wireless charging may be performed.

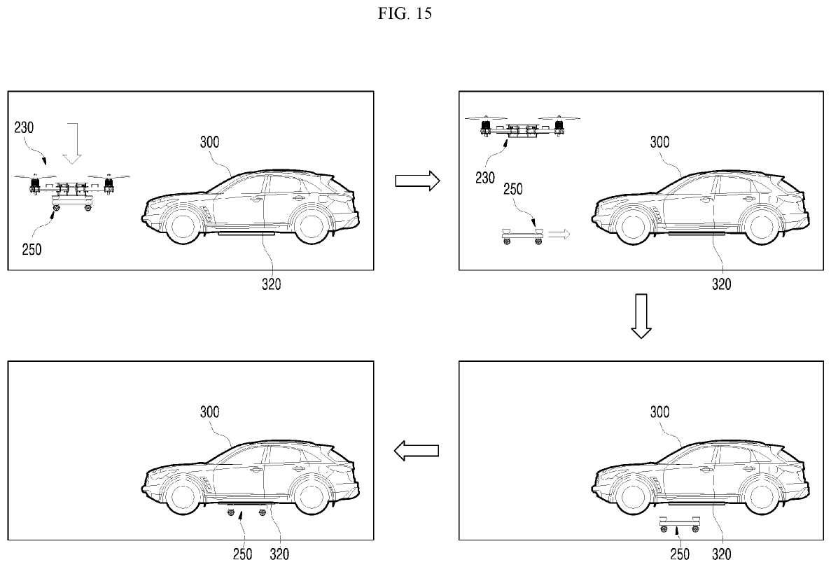

FIG. 15 is a diagram illustrating a bottom wireless charging method according to one embodiment of the present disclosure. Referring to FIG. 15, in the case where the bottom wireless charging mode is selected as the charging mode of the charge request vehicle 300, the charging controller 125 may move the wireless charging module 250 onto a random location on the road by controlling the charging assistance module 230 through the auxiliary module operator 126. Thereafter, the charging assistance module 230 may return to the mobile charging vehicle 200. Here, in the present embodiment, the wireless charging module 250 may autonomously drive to a set position. However, if the situation is such that autonomous driving is not possible, the wireless charging module 250 may be moved to the underside of the charge request vehicle 300 by the charging assistance module 230.

The charging controller 125 may perform control so as to move the wireless charging module 250 under the charge request vehicle 300, and cause the wireless charging module 250 to attach to the wireless power receiving pad 320 provided underneath the charge request vehicle 300.

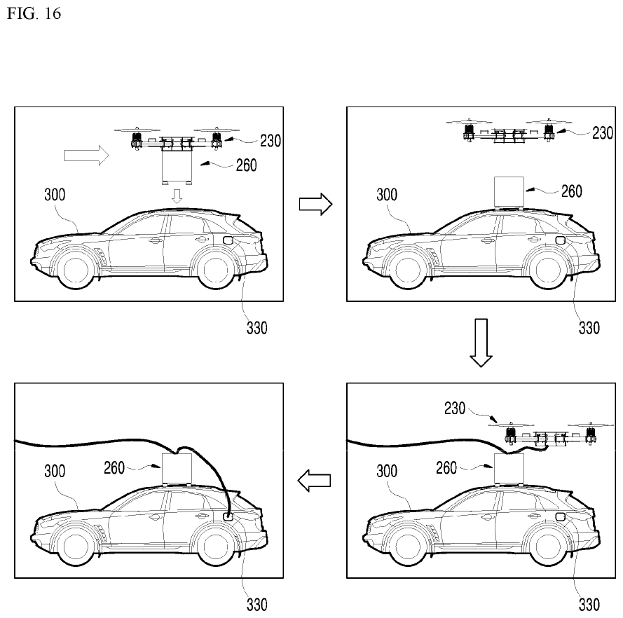

FIG. 16 is a diagram illustrating a wired charging method according to one embodiment of the present disclosure. Referring to FIG. 16, when the wired charging mode is selected as the charging mode of the charge request vehicle 300, the charging controller 125 may move the wired charging module 260 to the top of the charge request vehicle 300 by controlling the charging assistance module 230 through the auxiliary module operator 126. In addition, the charging controller 125 may control the wired charging fix/release modules (261 in FIG. 12) of the wired charging module 260 such that the wired charging module 260 is attached to the top of the charge request vehicle 300. Here, the charge location of the wired charging module 260 is not limited, and may be determined by the location of the charging port 330 of the charge request vehicle 300.

In addition, the charging assistance module 230 may connect the power supply line of the charge output module (240 in FIG. 3) of the mobile charging vehicle 200 to the input terminal of the wired charging module 260, and connect the power supply line of the output terminal to the charging port 330 of the charge request vehicle 300.

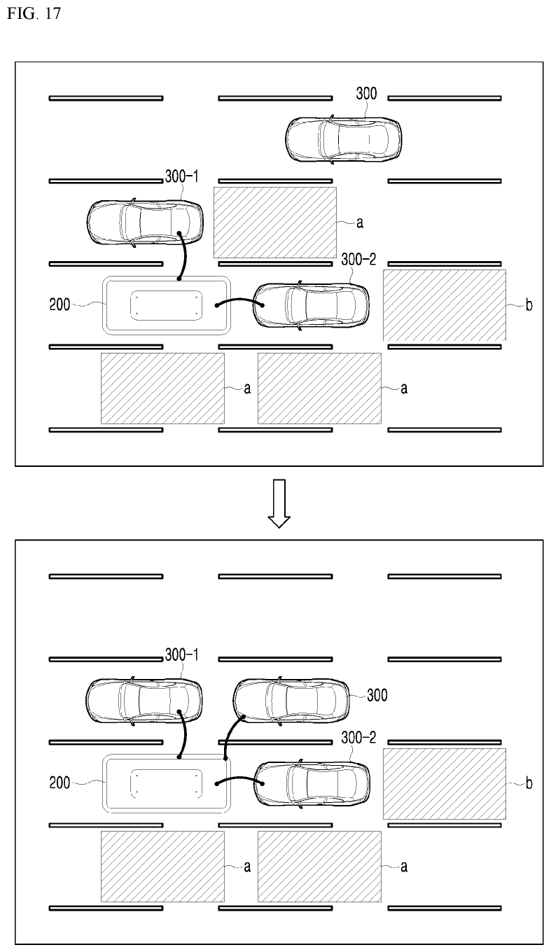

FIG. 17 is a schematic diagram illustrating a connection with a charge request vehicle according to one embodiment of the present disclosure. Referring to FIG. 17, the mobile charging vehicle 200, in response to receipt of a charge request from the charge request vehicle 300, may provide the charge request vehicle 300 with location information of charging-available areas a and b. Here, the area a of the charging-available areas a and b may be classified as an area near the mobile charging vehicle 200 where wired charging connection is immediately available. That is, after receiving the location information of a charging-available area, the charge request vehicle 300 may move to the charging-available area. Here, the charge request vehicle 300 may enter a charging-available area other than the charging-available areas where other vehicles 300-1 and 300-2 are being charged, to perform charging.

Meanwhile, in a case where the wired charging mode is selected as the charging mode of the charge request vehicle 300, if the charge request vehicle 300 has entered the charging-available areas a and b but another vehicle being charged is located in the closest area a, the charging controller 125 may enable the charge request vehicle 300 to be charged through the other vehicle being charged.

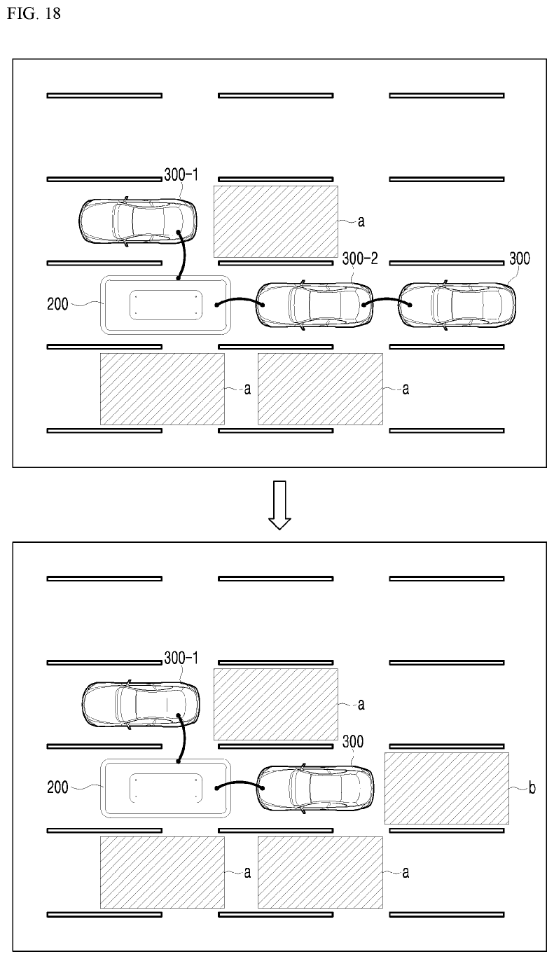

FIG. 18 is a diagram illustrating an inter-vehicle connection method according to one embodiment of the present disclosure. Referring to FIG. 18, in a case where the charge request vehicle 300 has entered the charging-available areas a and b but is unable to enter the closest area a, the charging controller 125 may connect, by using the charging assistance module 230, the power supply line of the output terminal of another vehicle 300-2 being charged to the input terminal of the charge request vehicle 300 to perform charging.

Once the charging of the other vehicle 300-2 being charged is finished, the charging controller 125 may disconnect the wired connection with the other vehicle 300-2 being charged, by using the charging assistance module 230. In addition, the charging controller 125 may cause the charge request vehicle 300 to move to the closest region a and connect the power supply line of the mobile charging vehicle 200 to the output port of the charge request vehicle 300 through the charging assistance module 230.

Meanwhile, when the mobile charging vehicle 200 and the charge request vehicle 300 are connected to each other by wire indirectly through another vehicle 300-n instead of being directly connected to each other by wire, there is a higher possibility of overlapping or tangling of power supply lines occurring, due to the location of vehicle or the location of charging port. In this regard, in the present embodiment, the wired charging module 260 is configured to be rotatable so that the overlapping and tangling of power supply lines can be prevented by rotating the wired charging module 260. Furthermore, when the overlapping and tangling of power supply lines cannot be prevented simply by rotating the wired charging module 260, the overlapping and tangling of power supply lines can be addressed by changing the locations of the charge request vehicle 300 and the other vehicle 300-n.

The charge state checker 127 is configured to check the state of charging progress of the charge request vehicle 300. The charging controller 125 can confirm whether or not the charging is completed, on the basis of the state of charging progress checked by the charge state checker 127. In addition, the charging controller 125 may confirm the charge level through the charge state checker 127 and provide a charge fee to the charge request vehicle 300.

Meanwhile, in the present embodiment, a monitoring manager 128 for monitoring events that occur during the process of charging the charge request vehicle 300 may be included. The monitoring manager 128 may receive monitoring information from a camera (not illustrated) provided in the mobile charging vehicle 200, or may receive monitoring information from a camera sensor (not illustrated) provided in the charging assistance module 230. In addition, the monitoring manager 128 may perform monitoring based on sensing information obtained from the sensors provided in the mobile charging vehicle 200, the charging assistance module 230, the wireless charging module 250, the wired charging module 260, and the like.

Here, in response to the monitoring result from the monitoring manager 128 indicating that the power supply line has collided with an object or the charge request vehicle 300 being charged has departed from the platoon, the charging controller 125 may terminate charging and disconnect the power supply line. For example, in the present embodiment, cases in which an object is confirmed through the camera to be approaching, or a collision is detected through a sensor of the power supply line, are determined to be occurrences of an unexpected event. That is, the charging controller 125 may monitor the surrounding environment in real time, so that in the event of an unexpected event, the charging controller 125 can immediately transmit a power supply line retrieve signal to the wired charging module 260 to immediately stop (block) the charging.

The battery manager 129 is configured to manage the battery state of the mobile charging vehicle 200. In the present embodiment, when the battery of the mobile charging vehicle 200 is insufficient, the mobile charging vehicle 200 may be replaced with another mobile charging vehicle 200-n prepositioned for continuous charging and platooning. Here, the modules provided in the mobile charging vehicle 200 may be moved to the other mobile charging vehicle 200-n by using the charging assistance module 230. In this case, the charging assistance module 230 and the moved modules can be re-registered in the other mobile charging vehicle 200-n. Once replaced, the mobile charging vehicle 200 that needs charging may be charged at a nearby charge station and move to a set standby location to stand by.

Accordingly, according to embodiments of the present disclosure, by using the mobile charging vehicle capable of wireless charging and wired charging and by having the mobile charging vehicle perform wireless charging or wired charging while driving in a platoon with vehicles that need to be charged, a plurality of electric vehicles can be charged simultaneously, thus increasing product satisfaction and reliability.

In addition, by mounting a large-capacity battery, it is possible to enable high-efficiency fast charging during wired charging, and increase efficiency during wireless charging, thus increasing the utility of a mobile charging service provision apparatus.

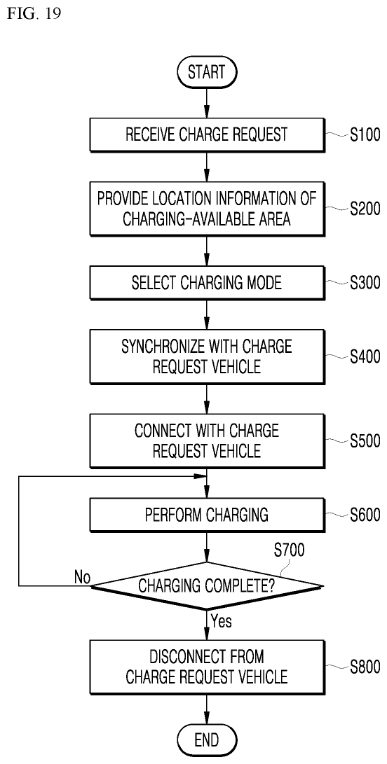

FIG. 19 is a flowchart illustrating a mobile charging service provision method according to one embodiment of the present disclosure. In the following description, repeated description of common parts previously described with reference to FIG. 1 through FIG. 18 will be omitted.

Referring to FIG. 19, the mobile charging service provision system 1 receives a charge request from more than one vehicle in S100. That is, a vehicle in need of charging can send a request to the mobile charging service provision system 1 for a charging service. Although the method of requesting a charging service is not specifically disclosed in the present embodiment, the user of the corresponding vehicle may request a charging service through the vehicle or a terminal. In addition, if the vehicle itself determines that it needs charging, the vehicle itself may request the charging service.

In S200, the mobile charging service provision system 1 provides location information of charging-available areas to the charge request vehicle 300 that has requested to be charged. That is, the mobile charging service provision system 1 may provide the location information of a charging-available area closest to the mobile charging vehicle 200 on the basis of the location of the charge request vehicle 300. Here, the location information of charging-available areas may be provided such that the charging-available areas are classified into close areas where a direct connection with the mobile charging vehicle 200 is available and charging-available areas where an indirect connection with another charging-request vehicle 300-n that is being charged while connected the mobile charging vehicle 200 is available. The charge request vehicle 300 that has received the location of a charging-available area may move to the corresponding area, and the mobile charging service provision system 1 may confirm whether or not the charge request vehicle 300 has entered the charging-available area.

In S300, when the charge request vehicle 300 enters the charging-available area, the mobile charging service provision system 1 collects vehicle information of the charge request vehicle 300 for charging, and selects a charging mode. Based on at least one of the charge state of the charge request vehicle 300, the charging type of the charge request vehicle 300, and the location of the charge request vehicle 300, the mobile charging service provision system 1 may select one of the top wireless charging mode, the bottom wireless charging mode, and the wired charging mode as the charging mode.

In S400, the mobile charging service provision system 1 provides the charge request vehicle 300 with driving information (speed and route) for platooning, performs synchronization, and enables platooning. Although the present embodiment describes that S400 is performed after S300, S300 and S400 may be performed simultaneously, or S300 may be performed after S400.

In S500, the mobile charging service provision system 1 enables a wireless or wired connection with the charge request vehicle 300 depending on the selected charging mode.

In addition, in S600, after confirming that the wireless connection or wired connection with the charge request vehicle 300 is completed, the mobile charging service provision system 1 performs charging of the charge request 300 vehicle while platooning.

If the top wireless charging mode is selected as the charging mode of the charge request vehicle 300, the mobile charging service provision system 1 may perform control such that the charging assistance module 230 lifts the wireless charging module 250 and moves the wireless charging module 250 to the top of the charge request vehicle 300 (the wireless power receiving pad). In addition, upon reaching the wireless power receiving pad on the top of the charge request vehicle 300, the wireless charging module 250 may be attached to the top of the charge request vehicle 300 by using the wireless charge fix/release module 251. After confirming that the wireless charging module 250 is properly attached to the location of the wireless charge receiving pad, the mobile charging service provision system 1 may proceed to perform charging.

In addition, in the mobile charging service provision system 1, when the bottom wireless charging mode is selected as the charging mode of the charge request vehicle 300, the charging controller 125 may cause the charging assistance module 230 to put down the wireless charging module 250 onto a random location on the road. Here, in the present embodiment, the wireless charging module 250 is a module capable of autonomously driving to a set location, and can travel to the set location (the underside of a charge request vehicle) to approach the underside of the charge request vehicle 300. In addition, upon arriving at the location of the wireless power receiving pad on the underside of the charge request vehicle 300, the wireless charging module 250 may be attached to the underside of the charge request vehicle 300 by using the wireless charge fix/release module 251. After confirming that the wireless charging module 250 is properly attached to the location of the wireless charge receiving pad, the mobile charging service provision system 1 may proceed to perform charging.

In addition, in the mobile charging service provision system 1, when the wired charging mode is selected as the charging mode of the charge request vehicle 300, the charging controller 125 may perform control such that the charging assistance module 230 transports the wired charging module 260 to the top of the charge request vehicle 300. In addition, the mobile charging service provision system 1 may control the wired charging fix/release modules 261 of the wired charging module 260 such that the wired charging module 260 is attached to the top of the charge request vehicle 300. In addition, the charging assistance module 230 may connect the power supply line of the charge output module 240 of the mobile charging vehicle 200 or the power supply line of the output terminal of another vehicle 300-n being charged with the mobile charging vehicle 200 to the input terminal of the charge request vehicle 300. Subsequently, the charging assistance module 230 may connect the power supply line of the output terminal of the wired charging module 260 to the charging port of the charge request vehicle 300. Here, the charging assistance module 230 may connect the output terminal closest to the charging port of the charge request vehicle 300, among the output terminals of the wired charging module 260, to the charging port the charge request vehicle 300.

In S700, the mobile charging service provision system 1 determines whether or not the charging is completed. The mobile charging service provision system 1 may determine whether or not the charging is completed by monitoring the charging progress.

In S800, once the charging is completed, the mobile charging service provision system 1 may disconnect the connection with the charge request vehicle 300. In a case in which the charge request vehicle 300 is connected based on the wireless top charging mode, the mobile charging service provision system 1 may, upon completion of the charging, transport the wireless charging module 250 to the mobile charging vehicle 200 by moving the charging assistance module 230 to the top of the charge request vehicle 300. In the present embodiment, the wireless charging module 250 may be returned to a pre-registered mobile charging vehicle 200, but depending on the setting, the wireless charging module 250 may be returned to another mobile charging vehicle 200. Here, when the charging assistance module 230 takes hold of the wireless charging module 250 on the top of the charge request vehicle 300, the wireless charge fix/release module 251 of the wireless charging module 250 can be released.

In addition, in a case in which the charge request vehicle 300 is connected based on the wireless bottom charging mode, the mobile charging service provision system 1 may, upon completion of the charging, perform control so as to cause the wireless charging module 250 to release from the charge request vehicle 300 and travel to a set location. In addition, the mobile charging service provision system 1 may return the wireless charging module 250 to the mobile charging vehicle 200 by using the charging assistance module 230.

Meanwhile, in a case in which the charge request vehicle 300 is connected based on the wired charging mode, the mobile charging service provision system 1 may disconnect the power supply line connected to the charging port of the charge request vehicle 300 by using the charging assistance module 230. Thereafter, the charging assistance module 230 may return to the mobile charging vehicle 200 with the wired charging module 260. Here, the power supply line connected to the mobile charging vehicle 200 may be released and collected.

According to embodiments of the present disclosure, by monitoring in real time the locations of the mobile charging vehicle and the charge request vehicle, a charging state, and nearby road conditions, it is possible to prevent unexpected events from occurring.

In addition, by training a deep neural network on the basis of data obtained from monitoring in real time the locations of the mobile charging vehicle and the charge request vehicle, a charging state, and nearby road conditions, it is possible to enable optimal charging.

In addition, by providing the mobile charging service through 5G network-based communications, and thereby enabling rapid data processing, it is possible to further improve the performance of the mobile charging service provision system.

In addition, although the mobile charging service provision apparatus is a mass-produced uniform product, since the user perceives it as a personalized device, the effects of being a user-customized product may be produced.

Embodiments of the present disclosure described above may be implemented in the form of computer programs that may be executed through various components on a computer, and such computer programs may be recorded in a computer-readable medium. Examples of the computer-readable medium may include, but are not limited to: magnetic media such as hard disks, floppy disks, and magnetic tapes; optical media such as CD-ROM disks and DVD-ROM disks; magneto-optical media such as floptical disks; and hardware devices that are specially configured to store and execute program commands, such as ROM, RAM, and flash memory devices.

The computer programs may be those specially designed and constructed for the purposes of the present disclosure or they may be of the kind well known and available to those skilled in the computer software arts. Examples of the computer programs may include both machine codes produced by a compiler, and higher level language code that may be executed by a computer using an interpreter.

As used in the present application (especially in the appended claims), the terms ‘a/an’ and ‘the’ include both singular and plural references, unless the context clearly states otherwise. Also, it should be understood that any numerical range recited herein is intended to include all sub-ranges subsumed therein (unless expressly indicated otherwise) and therefore, the disclosed numeral ranges include every individual value between the minimum and maximum values of the numeral ranges.

Also, the order of individual steps in methods disclosed in the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example”, etc.) used herein are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations may be made within the scope of the appended claims or equivalents thereof.

The present disclosure is thus not limited to the example embodiments described above, and rather intended to include the following appended claims, and all modifications, equivalents, and alternatives falling within the spirit and scope of the following claims.

### REFERENCES

1: Mobile charging service provision system
10: Cloud network
20: AI server
30a: Robot
30b: Autonomous vehicle
30c: XR Device
30d: User terminal (Smartphone)
30e: Home appliance

What is claimed is:

1. A mobile charging service provision method, comprising:
receiving a charge request from one or more vehicles;
providing location information of a charging-available area based on the location of a charge request vehicle requesting to be charged;
collecting vehicle information of the charge request vehicle upon entry of the charge request vehicle into the charging-available area, and selecting a charging mode;
transmitting driving information for platooning to the charge request vehicle;
establishing a connection for wireless power supply or wired power supply with the charge request vehicle, based on the selected charging mode; and
performing charging of the charge request vehicle, based on the connection.

2. The mobile charging service provision method of claim 1, wherein the selecting a charging mode comprises selecting one of a top wireless charging mode, a bottom wireless charging mode, or a wired charging mode as the charging mode, based on at least one of a charge state of the charge request vehicle, a charging type of the charge request vehicle, and the location of the charge request vehicle, included in the vehicle information,
wherein the top wireless charging mode and the bottom wireless charging mode are charging modes based on the location of a wireless charging pad with respect to the charge request vehicle.

3. The mobile charging service provision method of claim 1, wherein the establishing a connection for wireless power supply or wired power supply with the charge request vehicle based on the selected charging mode comprises controlling an unmanned aerial vehicle so as to move a wired charging module or a wireless charging module to a set location.

4. The mobile charging service provision method of claim 3, wherein the establishing a connection for wireless power supply or wired power supply with the charge request vehicle based on the selected charging mode comprises:
in the top wireless charging mode, controlling the unmanned aerial vehicle so as to move the wireless charging module to a top of the charge request vehicle; and
controlling the unmanned aerial vehicle so as to attach the wireless charging module to a wireless power receiving pad provided on the top of the charge request vehicle.

5. The mobile charging service provision method of claim 3, wherein the establishing a connection for wireless power supply or wired power supply with the charge request vehicle based on the selected charging mode comprises:
in the bottom wireless charging mode, controlling the unmanned aerial vehicle so as to move the wireless charging module onto a road;
controlling the wireless charging module so as to move the wireless charging module to an underside of the charge request vehicle; and
controlling the wireless charging module so as to attach the wireless charging module to a wireless power receiving pad provided on the underside of the charge request vehicle.

6. The mobile charging service provision method of claim 3, wherein the establishing a connection for wireless power supply or wired power supply with the charge request vehicle based on the selected charging mode comprises:
in the wired charging mode, controlling the unmanned aerial vehicle so as to move the wired charging module to the top of the charge request vehicle;
controlling the unmanned aerial vehicle so as to attach the wired charging module to the top of the charge request vehicle; and
controlling the unmanned aerial vehicle so as to connect a first power supply line of a charge output port of a mobile charging vehicle to an input terminal of the wired charging module, and connect a second power supply line of an output terminal of the wired charging module to a charging port of the charge request vehicle.

7. The mobile charging service provision method of claim 3, wherein the establishing a connection for wireless power supply or wired power supply with the charge request vehicle based on the selected charging mode comprises, in the wired charging mode, controlling the unmanned aerial vehicle so as to connect a third power supply line of an output terminal of a wired charging module attached to another vehicle being charged, to an input terminal of a wired charging module attached to the charge request vehicle.

8. The mobile charging service provision method of claim 7, comprising:
monitoring interference of power supply lines of the other vehicle and the charge request vehicle; and
requesting the other vehicle or the charge request vehicle to change location, so as to rotate at least one of a wired charging module attached to the other vehicle or a wired charging module attached to the charge request vehicle, or to change the location of at least one of the other vehicle or the charge request vehicle.

9. The mobile charging service provision method of claim 1, further comprising:
monitoring an event that occurs during charging of the charge request vehicle; and
based on the event, stopping the wired power supply and disconnecting a connection for the wired power supply.

10. A mobile charging service provision apparatus, comprising:
a charge request receiver configured to receive a charge request from one or more vehicles;
a charging location provider configured to provide location information of a charging-available area based on the location of a charge request vehicle requesting to be charged;
a vehicle information collector configured to collect vehicle information of the charge request vehicle upon entry of the charge request vehicle into the charging-available area;
a charging mode selector configured to select a charging mode based on the vehicle information of the charge request vehicle; and
a charge controller configured to transmit driving information for platooning to the charge request vehicle, establish a connection with the charge request vehicle for wireless power supply or wired power supply based on the selected charging mode, and perform charging of the charge request vehicle based on the connection.

11. The mobile charging service provision apparatus of claim 10,
wherein the charging mode selector is configured to select one of a top wireless charging mode, a bottom wireless charging mode, or a wired charging mode as a charging mode, based on at least one of a charge state of the charge request vehicle, a charging type of the charge request vehicle, or the location of the charge request vehicle, included in the vehicle information,
wherein the top wireless charging mode and the bottom wireless charging mode are charging modes based on the location of a wireless charging pad with respect to the charge request vehicle.

12. The mobile charging service provision apparatus of claim 10,
wherein the charge controller is configured to control an unmanned aerial vehicle so as to move a wired charging module or a wireless charging module to a set location.

13. The mobile charging service provision apparatus of claim 12,
wherein in the top wireless charging mode, the charge controller is configured to control the unmanned aerial vehicle so as to move the wireless charging module to a top of the charge request vehicle, and control the unmanned aerial vehicle so as to attach the wireless charging module to a wireless power receiving pad provided on the top of the charge request vehicle.

14. The mobile charging service provision apparatus of claim 12,
wherein in the bottom wireless charging mode, the charge controller is configured to control the unmanned aerial vehicle so as to move a wireless charging module onto a road, control the wireless charging module so as to move the wireless charging module to an underside of the charge request vehicle, and control the wireless charging module so as to attach the wireless charging module to a wireless power receiving pad provided on the underside of the charge request vehicle.

15. The mobile charging service provision apparatus of claim 12,
wherein in the wired charging mode, the charge controller is configured to control the unmanned aerial vehicle so as to move the wired charging module to the top of the charge request vehicle, control the unmanned aerial vehicle so as to attach the wired charging module to the top of the charge request vehicle, and control the unmanned aerial vehicle so as to connect a first power supply line of a charging output port of a mobile charging vehicle to an input terminal of the wired charging module and connect a second power supply line of an output terminal of the wired charging module to a charging port of the charge request vehicle.

16. The mobile charging service provision apparatus of claim 12,
wherein in the wired charging mode, the charge controller is configured to control the unmanned aerial vehicle so as to connect a third power supply line of an output terminal of a wired charging module attached to another vehicle being charged, to an input terminal of a wired charging module attached to the charge request vehicle.

17. The mobile charging service provision apparatus of claim 16, further comprising a monitoring manager configured to monitor interference of power supply lines of the other vehicle and the charge request vehicle,
wherein the charge controller is configured to request the other vehicle or the charge request vehicle to change location, so as to rotate at least one of a wired charging module attached to the other vehicle and a wired charging module attached to the charge request vehicle, or to change the location of at least one of the other vehicle and the charge request vehicle, based on the interference.

18. The mobile charging service provision apparatus of claim 17,
wherein the monitoring manager is configured to monitor an event occurring during charging of the charge request vehicle, and based on the event, the charge controller is configured to stop the wired power supply and disconnect a connection for the wired power supply.

19. A mobile charging service provision system, comprising:
a mobile charging vehicle configured to establish a connection with one or more charge request vehicles for wireless power supply or wired power supply, and perform charging of the charge request vehicle based on the connection;
a charge request vehicle configured to send a charge request to the mobile charging vehicle and receive location information of a charging-available area, and move to the charging-available area; and
a server configured to receive a charge request from one or more vehicles, provide location information of a charging-available area based on a location of a charge request vehicle, collect vehicle information of the charge request vehicle based on entry of the charge request vehicle into the charging-available area, select a charging mode, and transmit driving information for platooning to the charge request vehicle,
wherein the mobile charging vehicle is configured to control an unmanned aerial vehicle so as to move a wired charging module or a wireless charging module to a set location to establish a connection for wireless power supply or wired power supply with the charge request vehicle, based on the selected charging mode.

20. The mobile charging service provision system of claim 19,
wherein the server is configured to select one of a top wireless charging mode, a bottom wireless charging mode, or a wired charging mode as the charging mode, based on at least one of a charge state of the charge request vehicle, a charging type of the charge request vehicle, or the location of the charge request vehicle, included in the vehicle information, wherein the top wireless charging mode and the bottom wireless charging mode are charging modes based on the location of a wireless charging pad with respect to the charge request vehicle.
